(19) United States
(12) Patent Application Publication
(10) Pub. No.: US 2026/0153725 A1
(43) Pub. Date: Jun. 4, 2026

(54) ROTARY RECIPROCATING DRIVE ACTUATOR

(71) Applicants: Yuki OTSUKA, Tokyo (JP); Yuki TAKAHASHI, Tokyo (JP); Masaharu KAGAMI, Tokyo (JP); Yasutaka KITAMURA, Tokyo (JP)

(72) Inventors: Yuki OTSUKA, Tokyo (JP); Yuki TAKAHASHI, Tokyo (JP); Masaharu KAGAMI, Tokyo (JP); Yasutaka KITAMURA, Tokyo (JP)

(73) Assignee: Mitsumi Electric Co., Ltd., Tokyo (JP)

(21) Appl. No.: 19/403,041

(22) Filed: Nov. 27, 2025

(30) Foreign Application Priority Data
Nov. 29, 2024 (JP) 2024-208833
Nov. 29, 2024 (JP) 2024-208844

(51) Int. Cl. G02B 26/10; H02K 33/16

(52) U.S. Cl. CPC G02B 26/105; H02K 33/16

(57) ABSTRACT

A rotary reciprocating drive actuator includes: an attachment surface portion joined to an attachment target portion; a rotatable shaft part that protrudes from a predetermined position of the attachment surface portion and to which a movable object is connected; and a core including: a pair of rod-shaped magnetic materials having magnetic poles at distal end portions, the magnetic poles facing an outer periphery of the magnet and a frame-shaped magnetic material connected to base end portions of the pair of rod-shaped magnetic materials and forming a magnetic path surrounding the magnet and the magnetic poles, in which the predetermined position is a position eccentrically offset from a center in a direction towards a corner portion on the attachment surface portion, and the pair of rod-shaped magnetic materials are symmetrically disposed with respect to an oblique line extending in the direction.

### RELATED APPLICATIONS

This application claims the benefit of priority of Japanese Patent Application Nos. 2024-208833 and 2024-208844, both filed on Nov. 29, 2024, the contents of which are all incorporated by reference as if fully set forth herein in their entirety.

### TECHNICAL FIELD

The present invention relates to a rotary reciprocating drive actuator.

### BACKGROUND ART

Conventionally, a rotary reciprocating drive actuator is used as an actuator used in an optical scanning apparatus such as a multifunctional machine, a laser beam printer, or the like. Specifically, the rotary reciprocating drive actuator causes a reciprocating rotation of the mirror of the scanner to change a reflection angle of a laser beam to achieve optical scanning of an object.

Patent Literature (hereinafter, referred to as “PTL”) 1 discloses a galvanometer motor as this type of rotary reciprocating drive actuator. As galvanometer motors, various types of galvanometer motors are known in addition to the type of galvanometer motor with the structure disclosed in PTL 1 and a galvanometer motor of a movable coil type in which a coil is attached to a mirror.

PTL 1 discloses a beam scanner in which four permanent magnets are disposed on a rotation shaft to which the mirror is attached, such that the permanent magnets are magnetized in the radial direction of the rotation shaft, and in which magnetic poles of a salient-pole yoke around which a coil is wound are disposed to sandwich the rotation shaft.

Note that, a main body of the salient-pole yoke is disposed to extend along and below the rotation shaft.

### CITATION LIST

### Patent Literature

PTL 1: U.S. Pat. No. 4,727,509

### SUMMARY OF INVENTION

### Technical Problem

In the beam scanner and the like of PTL 1, it is required to secure a rotation region of the mirror attached to the rotation shaft and to secure installation regions for the salient-pole yoke, the coil, and/or a magnet for rotating the rotation shaft. In order to secure these, a galvanometer motor has a predetermined height (length) from an attachment surface to which a product is attached up to an upper side portion (one side portion).

In recent years, in beam scanners and the like, it has been desired to reduce the size and/or profile of a rotary reciprocating drive actuator, such as a galvanometer motor mounted therein, while securing the rotation region of the mirror and the installation regions of the coil and the magnet without lowering the output of the rotary reciprocating drive actuator.

An object of the present invention is to provide a rotary reciprocating drive actuator that can achieve an increased amplitude by rotary drive with high torque and that can be reduced in size or profile.

### Solution to Problem

In order to achieve the above object, one aspect of a rotary reciprocating drive actuator according to the present invention is configured to include:
an attachment surface portion joined to an attachment target portion;
a rotatable shaft part that protrudes from a predetermined position of the attachment surface portion and to which a movable object is connected;
a magnet fixed to an outer periphery of the rotatable shaft part;
a core including:
   a pair of rod-shaped magnetic materials having magnetic poles at distal end portions, the magnetic poles facing an outer periphery of the magnet and
   a frame-shaped magnetic material connected to base end portions of the pair of rod-shaped magnetic materials and forming a magnetic path surrounding the magnet and the magnetic poles; and
a coil that generates magnetic flux in the core through energization to reciprocally rotate the rotatable shaft part, the magnetic flux interacting with the magnet, wherein
the predetermined position is a position eccentrically offset from a center in a direction towards a corner portion on the attachment surface portion, and
the pair of rod-shaped magnetic materials are symmetrically disposed with respect to an oblique line extending in the direction.

### Advantageous Effects of Invention

According to the present invention, it is possible to achieve an increased amplitude by rotary drive with high torque and to reduce the size or profile of the rotary reciprocating drive actuator.

### BRIEF DESCRIPTION OF DRAWINGS

FIG. 1 is an external perspective view of a rotary reciprocating drive actuator according to an embodiment of the present invention;

FIG. 2 is a left side view of the rotary reciprocating drive actuator according to the embodiment of the present invention;

FIG. 3 is a sectional view taken along line A-A of FIG. 2;

FIG. 4 is an exploded view of the rotary reciprocating drive actuator according to the embodiment of the present invention;

FIG. 5 is an external perspective view of a drive unit of the rotary reciprocating drive actuator according to the embodiment of the present invention;

FIG. 6 is a sectional view of the drive unit taken along line A-A of FIG. 2;

FIG. 7 is an exploded perspective view showing an internal configuration of the drive unit;

FIG. 8 is an exploded perspective view of the drive unit of FIG. 7 as viewed from a bottom cover side;

FIG. 9 is a view showing an internal configuration of the drive unit;

FIG. 10 is an exploded view of a core body;

FIG. 11 is a view of the core body of FIG. 10 as viewed from the bottom cover side;

FIG. 12 is a view showing an overall configuration of the core body;

FIG. 13 is an exploded perspective view of the drive unit;

FIG. 14 is an enlarged view of a preload part of the rotary reciprocating drive actuator;

FIG. 15 is a view showing a variation of the preload part of the rotary reciprocating drive actuator;

FIG. 16 is a view for describing a magnetic circuit configuration of the rotary reciprocating drive actuator;

FIG. 17 is a view for describing a method of applying a preload in the rotary reciprocating drive actuator; or

FIG. 18 is a block diagram showing a main configuration of an example of a scanner system including the rotary reciprocating drive actuator.

### DESCRIPTION OF EMBODIMENTS

Hereinafter, an embodiment of the present invention will be described in detail with reference to the drawings.

Parts constituting the rotary reciprocating drive actuator according to the present embodiment will be described by referring to a position of each part in a normal state in which the rotary reciprocating drive actuator is not driven and is in a non-operation state as a reference position that is a position serving as a reference for the operation of each part. In addition, in describing the structure of the rotary reciprocating drive actuator according to the present embodiment, a rectangular coordinate system (X, Y, Z) is used. The same rectangular coordinate system (X, Y, Z) is used in the figures described below. In addition, in the present embodiment, in order to describe the configuration and the operation of the rotary reciprocating drive actuator, the X direction is expressed as a right direction, the −X direction is expressed as a left direction, and the Z direction is expressed as an upward direction. The expressions indicating the directions are relative, not absolute, and are appropriate in a case in which each part of the rotary reciprocating drive actuator is in a posture shown in the figure, but should be interpreted as being changed in accordance with a change in the posture in a case in which the posture is changed.

### <Overall Configuration of Rotary Reciprocating Drive Actuator>

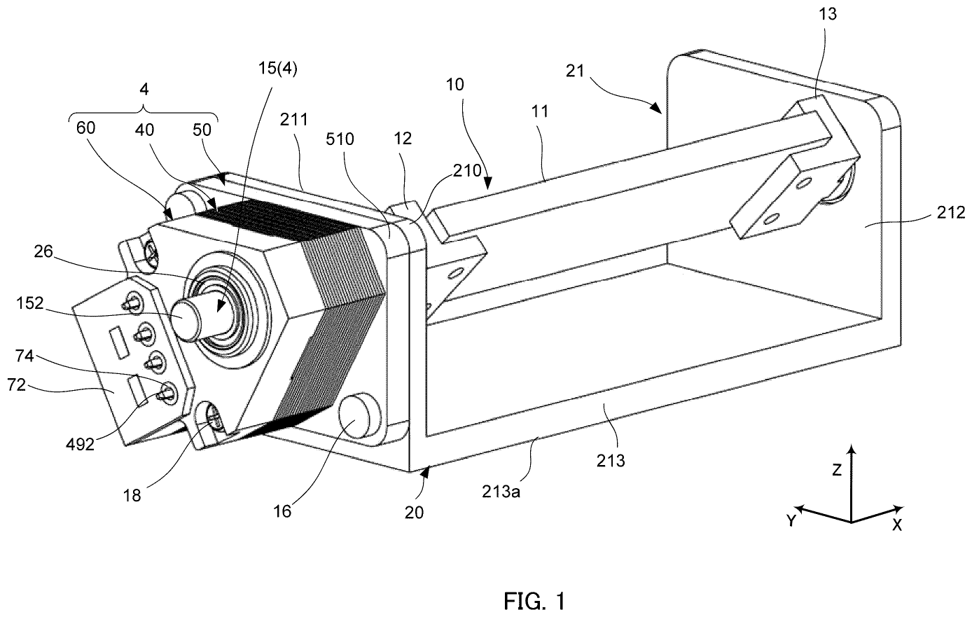

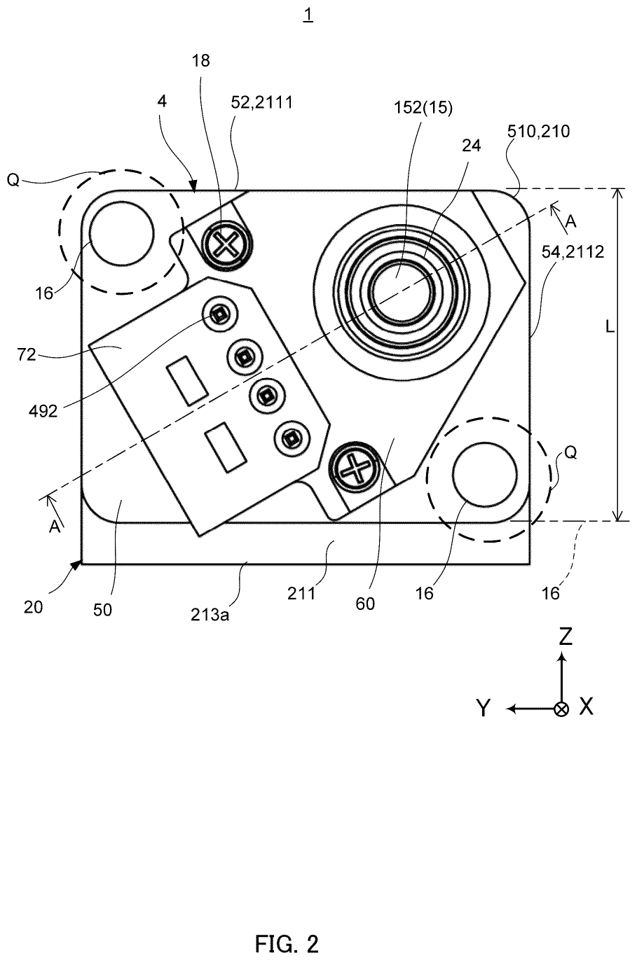

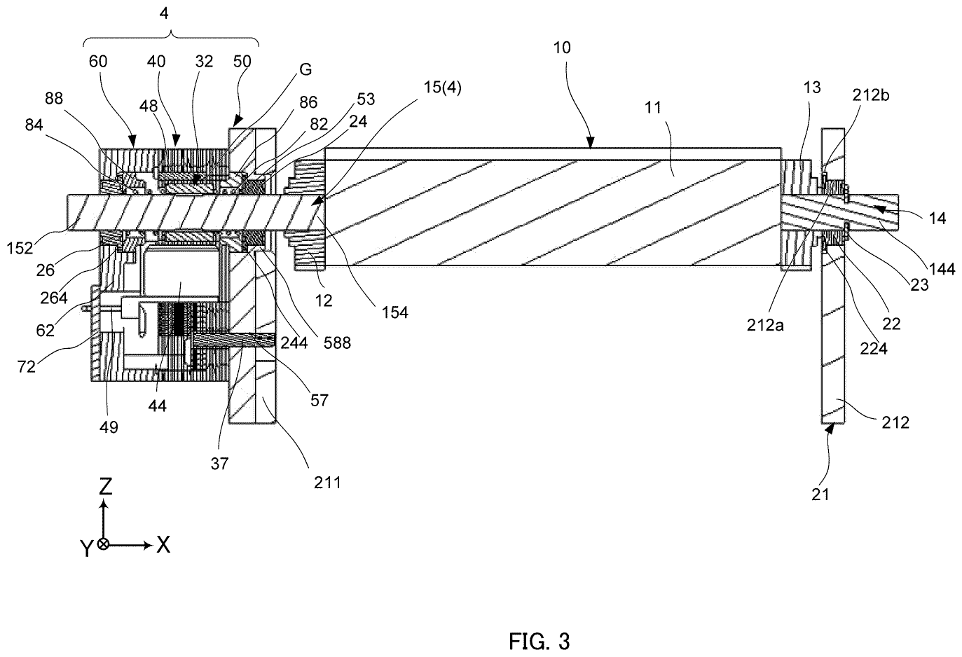

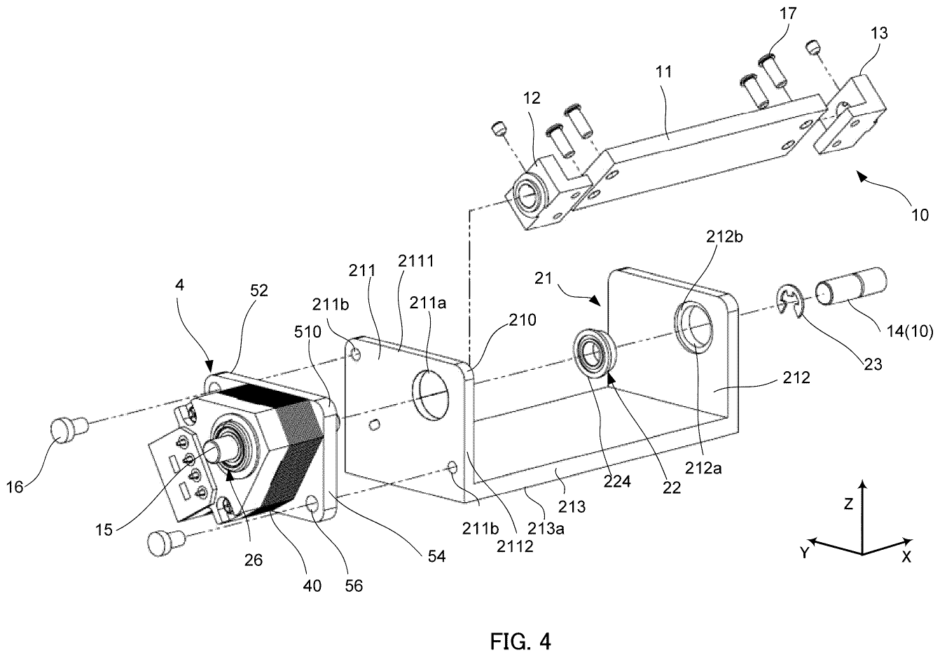

FIG. 1 is an external perspective view of a rotary reciprocating drive actuator according to an embodiment of the present invention, and FIG. 2 is a left side view of the rotary reciprocating drive actuator according to the embodiment of the present invention. In addition, FIG. 3 is a sectional view taken along line A-A of FIG. 2, and FIG. 4 is an exploded view of the rotary reciprocating drive actuator according to the embodiment of the present invention.

Rotary reciprocating drive actuator 1 reciprocally rotates and drives movable body 10 to which a movable object is connected around first shaft part 15 and second shaft part 14. Rotary reciprocating drive actuator 1 includes, for example, mirror part 11 as a movable object in movable body 10. Rotary reciprocating drive actuator 1 is used in light detection and ranging (LiDAR) or the like. In the LiDAR, rotary reciprocating drive actuator 1 is used as an optical scanner that emits laser light or the like to a scanning target via mirror part 11, acquires reflected light, and acquires information on the scanning target. Rotary reciprocating drive actuator 1 can be applied to a scanning device such as a multifunctional machine and a laser beam printer. In particular, rotary reciprocating drive actuator 1 can suitably function even in a situation in which an external force is applied, and is preferably applied to a device that may receive an impact during traveling, for example, a vehicle-mounted scanner device.

Rotary reciprocating drive actuator 1 includes, broadly, movable body 10, base part 21 that rotatably supports movable body 10, and drive unit 4 that drives a reciprocating rotation of movable body 10 with respect to base part 21.

Movable body 10 includes mirror part 11 that is a movable object, second shaft part (spindle) 14, and holders (mirror holders) 12 and 13, and is connected to first shaft part (spindle) 15 in drive unit 4. First shaft part 15 constitutes a movable portion of drive unit 4 together with magnet 32. In addition, first shaft part 15 is an output shaft that outputs a driving force of drive unit 4 to movable body 10. Magnet 32 is fixed to first shaft part 15 on one end portion 152 side, and mirror part 11 is connected to the other end portion side.

Movable body 10 is reciprocally rotatably supported by base part 21 via first shaft part 15 of drive unit 4 fixed to base part 21 and second shaft part 14. Base part 21 constitutes fixed body 20 that reciprocally rotates and supports movable body 10 together with a portion of drive unit 4 including coils 44, which is fixed to base part 21.

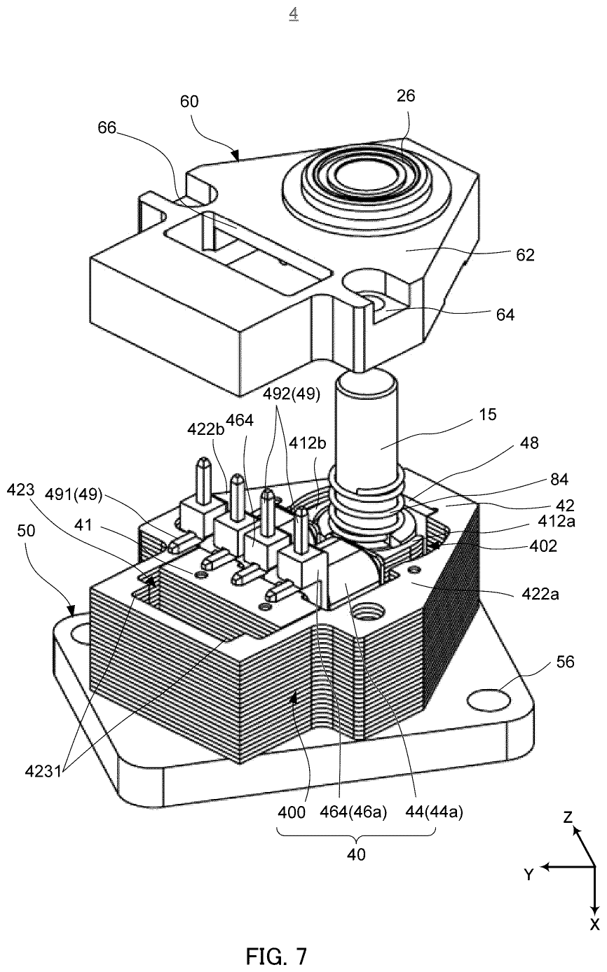

In rotary reciprocating drive actuator 1, magnet 32 (see FIG. 3) is disposed in core assembly 40, and first shaft part 15 is inserted into core assembly 40. Core assembly 40 includes coils 44, core body 400 (see FIGS. 7 to 13), and magnet reference position holding part (hereinafter, also referred to as a “reference position holding part”) 48. Drive unit 4 includes core assembly 40, magnet 32, first shaft part 15, bottom cover 50, and top cover (lid part) 60.

In drive unit 4, first shaft part 15 is driven and reciprocally rotates by cooperation between coils 44 that are energized, reference position holding part 48, magnet 32, and core body 400 (see FIG. 7). By the rotation of first shaft part 15, the movable object (mirror part 11) connected to first shaft part 15 reciprocally rotates around first shaft part 15 and second shaft part 14. Details of the configurations of drive unit 4 and core assembly 40 will be described below.

Mirror part 11 is rotatably attached to base part 21 together with first shaft part 15, second shaft part 14, and holders 12 and 13 of drive unit 4. Wall portion 211 corresponds to an attachment target portion, and an attachment surface portion corresponds to bottom cover 50.

Mirror part 11 is a movable object in rotary reciprocating drive actuator 1. Mirror part 11 includes a mirror surface. The mirror surface functions as a reflecting surface that reflects scanning light. The shape of the reflecting surface may be any shape such as a rectangular plate shape, a disk shape, or a V-shape. In the present embodiment, mirror part 11 includes, for example, an elongated plate-shaped body having a rectangular reflecting surface.

Holders 12 and 13 are attached to both end portions of mirror part 11 in the longitudinal direction, for example, the axial direction via fastening members 17 (see FIG. 4), and mirror part 11 is connected to first shaft part 15 and second shaft part 14 via holders 12 and 13. First shaft part 15 is connected to holder 12, and second shaft part 14 is connected to holder 13. First shaft part 15 and second shaft part 14 are disposed to be positioned on the same axis and to be positioned on the axis of mirror part 11. Holders 12 and 13 are firmly connected to first shaft part 15 and second shaft part 14 via fastening members such as a set screw shown in the figure.

First shaft part 15 and second shaft part 14 are inserted into and supported by a pair of wall portions 211 and 212 (first wall portion 211 and second wall portion 212) of base part 21, respectively.

As shown in FIGS. 1, 3, and 4, base part 21 rotatably supports mirror part 11 that is a movable object to be sandwiched from both sides in the axial direction via the shaft parts (first shaft part 15 and second shaft part 14).

### <Base Part 21>

Base part 21 includes bottom portion 213 having a top surface that is a plane and faces mirror part 11 and that extends in the axial direction. The pair of wall portions 211 and 212 are provided at both end portions of bottom portion 213 to stand up in parallel to face each other. Base part 21 is formed with a substantially U-shaped section by bottom portion 213 and the pair of wall portions 211 and 212.

The pair of wall portions 211 and 212 are each a substantially rectangular (including a rectangular) plate-shaped body, and entire base part 21 has a rectangular parallelepiped shape.

The pair of wall portions 211 and 212 are formed with insertion holes 211a and 212a, and first shaft part 15 and second shaft part 14 are inserted into insertion holes 211a and 212a, respectively, and are disposed on the same straight line. In particular, bearing (wall bearing) 22 is provided in insertion hole 212a of wall portion 212, and second shaft part 14 is supported by wall portion 212 via bearing 22.

Insertion holes 211a and 212a are formed at positions that are eccentric as viewed in the axial direction in wall portions 211 and 212, that is, in the vicinity of one corner portions 210 of the upper portions of wall portions 211 and 212.

As a result, in base part 21, mirror part 11 is disposed between wall portions 211 and 212 at a position in the vicinity of one corner portions 210 via second shaft part 14 and first shaft part 15.

Specifically, insertion hole 211a is provided at a position closer to corner portion 210 formed by side portions 2111 and 2112 orthogonal to each other in wall portion 211 than to a center position as viewed in the axial direction in wall portion 211. With this configuration, in a case in which mirror part 11 reciprocally rotates, the incidence of the scanning light into mirror part 11 and the emission of the scanning light from mirror part 11 are not hindered (blocked) by base part 21 itself, and as a result, suitable scanning can be realized.

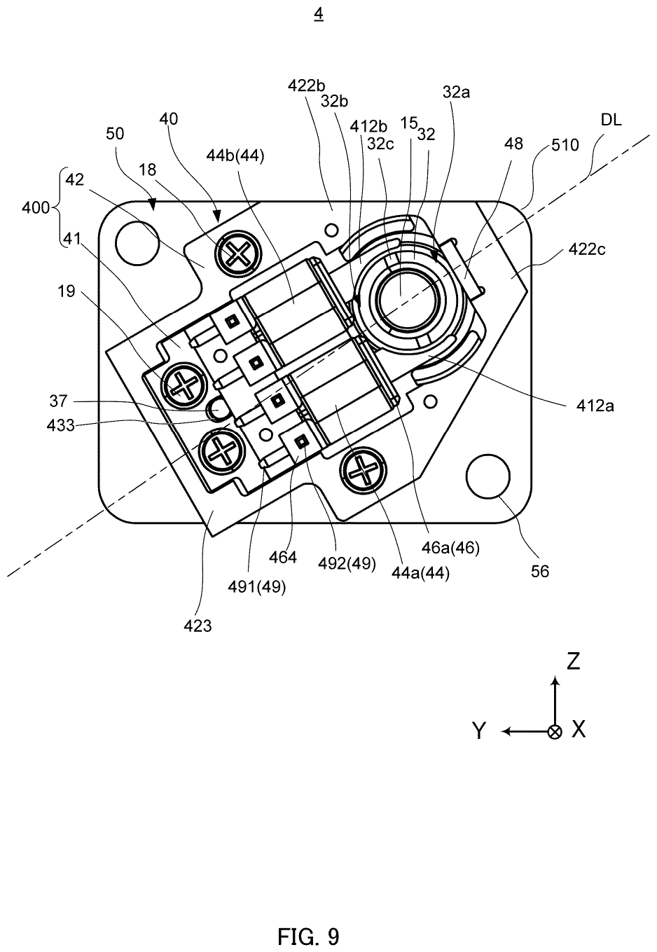

It is preferable that insertion holes 211a and 212a are formed at positions on the diagonal line in wall portions 211 and 212, respectively. Here, the diagonal line in wall portions 211 and 212 is a line that is inclined and extends to match diagonal line DL (see FIG. 9) in bottom cover 50. Diagonal line DL of bottom cover 50 is a line that extends by connecting a pair of diagonals in bottom cover 50, and is an example of an oblique line that extends in a direction from the center toward corner portion 510 in bottom cover 50. It is particularly preferable that insertion holes 211a and 212a are formed at positions in the vicinity of corner portions 210 on the diagonal line in wall portions 211 and 212, respectively. As a result, first shaft part 15 and second shaft part 14 can be disposed at positions on the diagonal line of wall portions 211 and 212, that is, at positions in the vicinity of corner portion 210 shifted upward from the center in the Z direction in wall portions 211 and 212.

As a result, the configuration is obtained in which the rotation center and the rotation region of mirror part (movable object) 11 set by first shaft part 15 and second shaft part 14 are positioned at positions shifted from the centers of wall portions 211 and 212, for example, at positions shifted in the Z direction (upward). According to this configuration, length L between the pair of opposite sides facing each other in the shift direction (Z direction) can be shortened as compared to a case in which the rotation center of mirror part 11 is positioned at the center of wall portions 211 and 212 as viewed in the axial direction. That is, since length L of wall portions 211 and 212 in the Z direction and length L of bottom cover 50 in the Z direction can also be shortened, a reduction in height can be realized.

Bearing 22 has flange 224 on an outer peripheral portion of one open end portion of an annular body portion that opens at the center, and is fitted into insertion hole 212a from the inside. Insertion hole 212a is provided with counterbore portion 212b (see FIGS. 3 and 4) that is a step at an opening edge portion on the axially inner side.

Bearing 22 is fitted into wall portion 212 from the axially inner side, and flange 224 restricts the movement of bearing 22 to the axially outer side. Second shaft part 14 that protrudes from holder 13 is inserted into bearing 22, and shaft movement restricting part 23 such as an E-ring is externally fitted to a portion of second shaft part 14 that protrudes to the outer surface side of wall portion 212. As described above, bearing 22 is engaged with wall portion 212 from the inside to restrict the movement of the first shaft part and mirror part 11 in the axial direction toward the outer side of wall portion 212.

Shaft movement restricting part 23 is disposed on the outer surface side of wall portion 212, restricts the movement of second shaft part 14 to the axially inner side, and prevents second shaft part 14 from being pulled out from wall portion 212 to the axially inner side.

First shaft part 15 connected to holder 12 is inserted into insertion hole 211a. First shaft part 15 is disposed to protrude from drive unit 4 fixed to the outer surface of wall portion 211 into base part 21.

### <Drive Unit 4>

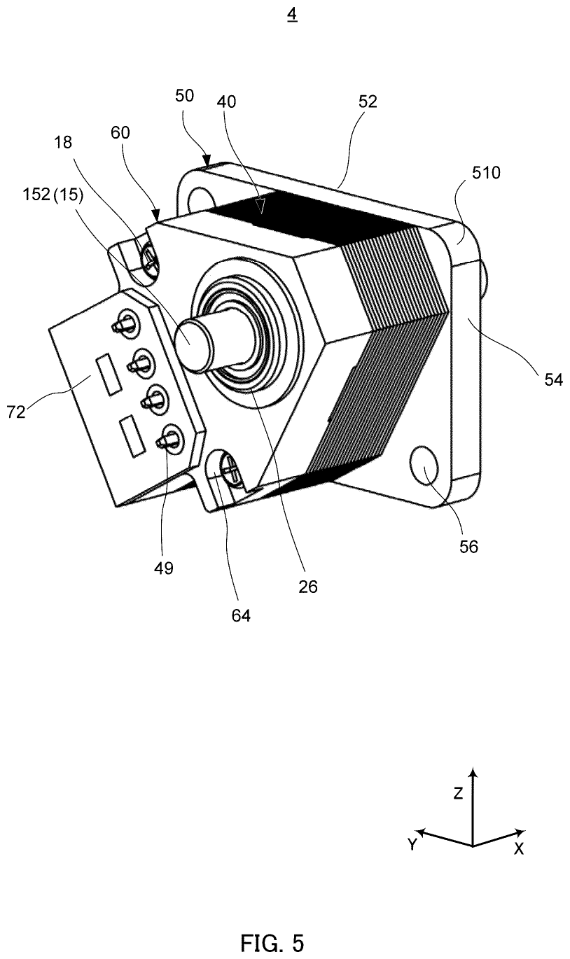

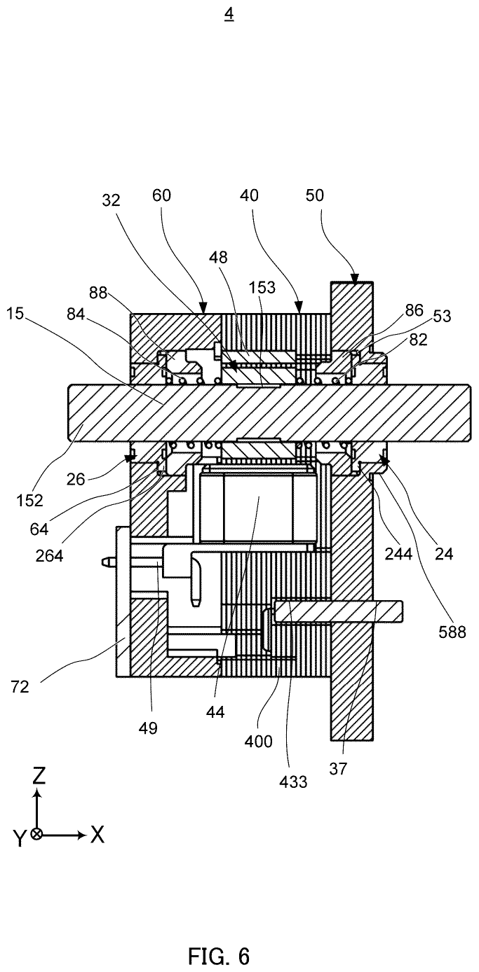

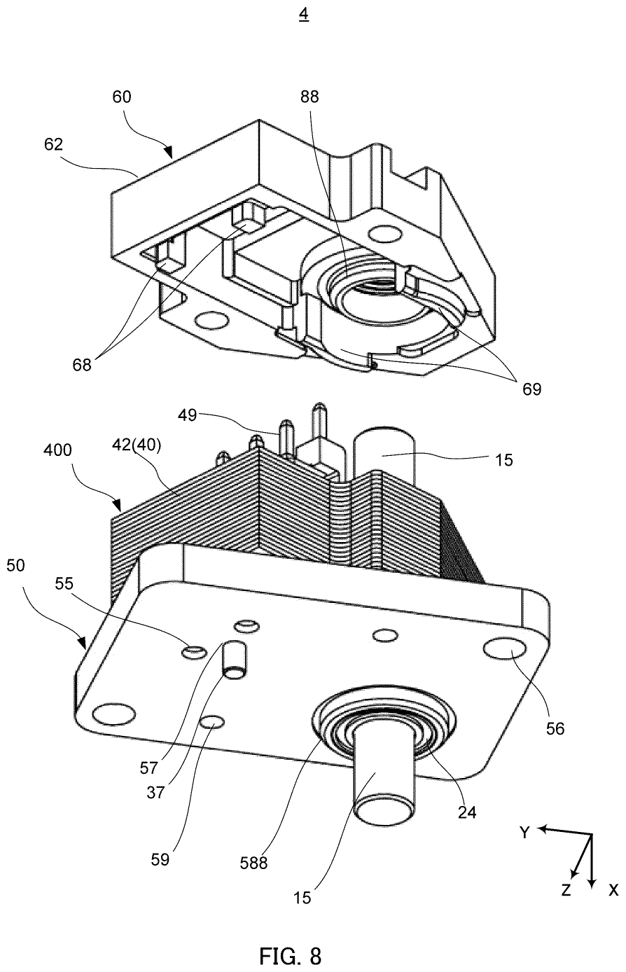

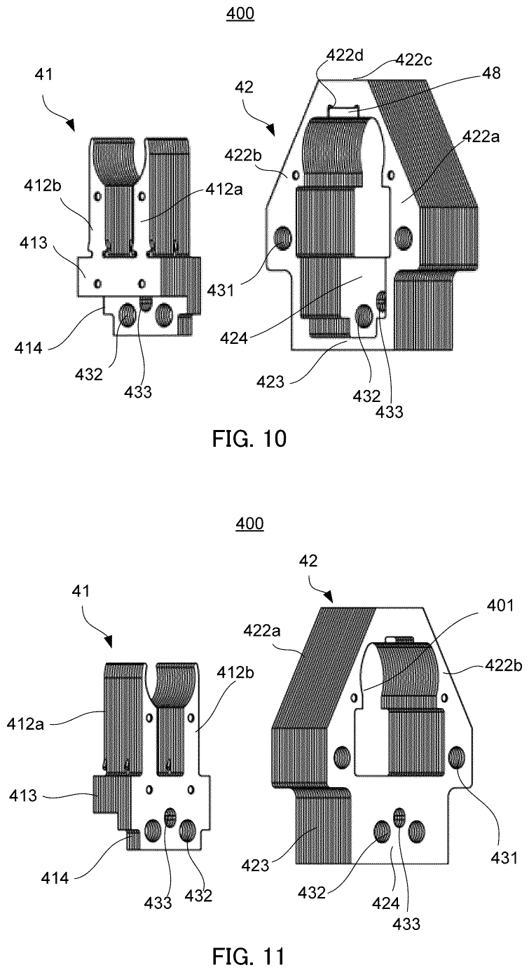

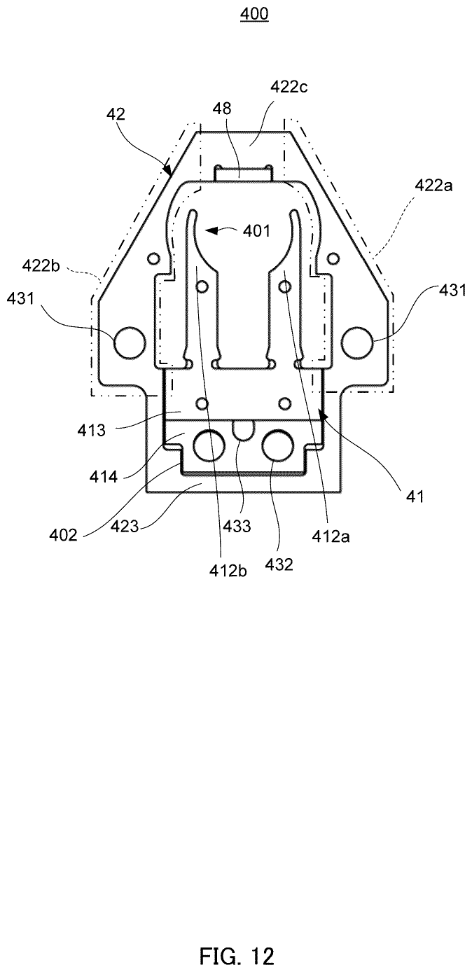

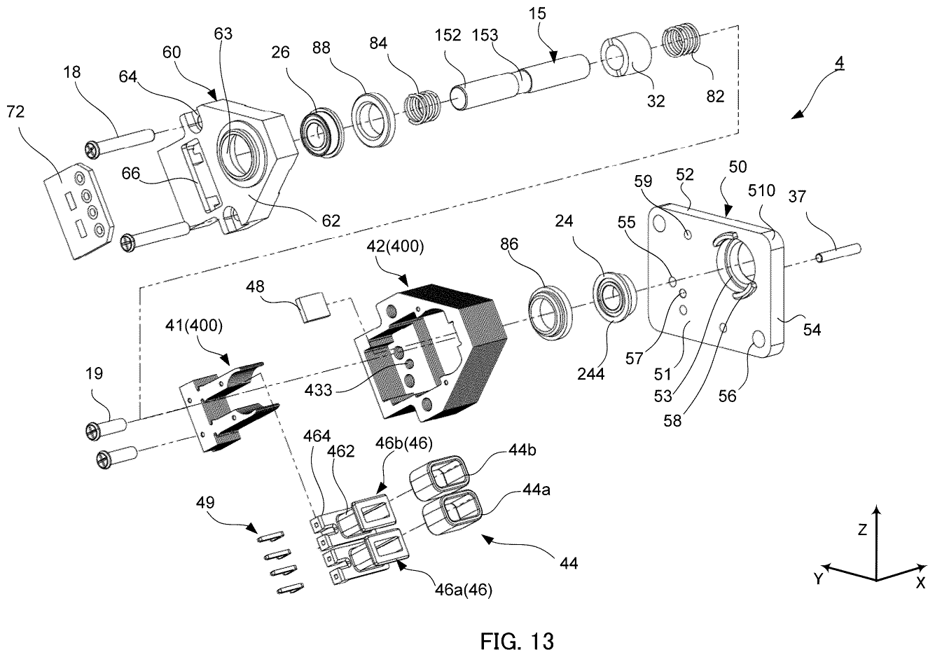

FIG. 5 is an external perspective view of a drive unit of a rotary reciprocating drive actuator according to the embodiment of the present invention, and FIG. 6 is a sectional view of the drive unit taken along line A-A of FIG. 2. In addition, FIG. 7 is an exploded perspective view showing an internal configuration of the drive unit, and FIG. 8 is an exploded perspective view of the drive unit of FIG. 7 as viewed from a bottom cover side. FIG. 9 is a view showing an internal configuration of the drive unit, and FIG. 10 is an exploded view of a core body. FIG. 11 is a view of the core body of FIG. 10 as viewed from a lower side, and FIG. 12 is a view showing an overall configuration of the core body. In addition, FIG. 13 is an exploded perspective view of the drive unit.

Drive unit 4 shown in FIGS. 1 to 9 is attached to one (specifically, wall portion 211) of both end portions of base part 21 spaced apart from each other in the axial direction, and drives a reciprocating rotation of mirror part 11 disposed in base part 21.

Drive unit 4 is fixed to the outer surface of wall portion 211 via fastening members 16. Fastening members 16 may be, for example, a male screw such as a screw, or may be a bolt-and-nut set. Here, two fastening members 16 are fastened to bring drive unit 4 into surface contact with wall portion 211 at a position at a shorter distance to wall portion 211 than the axial length of first shaft part 15 of drive unit 4, and to stack drive unit 4 and wall portion 211 on one another.

Drive unit 4 includes core assembly 40, bottom cover 50, and top cover 60 together with first shaft part 15 and magnet 32. Drive unit 4 accommodates magnet 32 in a fixed side unit fixed to wall portion 211 in a state in which first shaft part 15 is inserted through the magnet. A side of drive unit 4 in which magnet 32 is accommodated is a side (fixed side) of drive unit 4 fixed to wall portion 211. A movable side unit in drive unit 4 is formed.

Bottom cover 50 is formed in a plate shape (here, a rectangular plate shape), and is, for example, a shape having a smaller surface area than wall portion 211 and stacked within the outer surface of wall portion 211. Drive unit 4 is fixed to wall portion 211 via fastening members 16 at positions Q diagonally opposite to each other with core assembly 40 interposed therebetween as viewed from the front surface side of bottom cover 50 in the rectangular bottom cover 50. The front surface side of bottom cover 50 is the left side of rotary reciprocating drive actuator 1, in other words, the negative side in the X direction. Drive unit 4 is fixed to wall portion 211 at positions diagonally opposite to each other with bottom cover 50 disposed on wall portion 211 in a stacked manner. Therefore, drive unit 4 can be firmly attached to base part 21 without rotating around first shaft part 15.

Core assembly 40 is disposed on bottom cover 50 to surround first shaft part 15 and magnet 32 in a direction (or a circumferential direction) orthogonal to the axial direction. Top cover 60 is attached to core assembly 40 to be stacked thereon in the axial direction.

Drive unit 4 includes first shaft part 15 such that the first shaft part protrudes in the axial direction at a position in the vicinity of corner portion 510 formed by side portions 52 and 54 orthogonal to each other. The position in the vicinity of corner portion 510 is a position shifted to corner portion 510 from the center of bottom cover 50 as viewed from the front surface side of bottom cover 50.

Core assembly 40 includes a trapezoidal shape portion (mountain shape portion) disposed to surround first shaft part 15 in a direction orthogonal to first shaft part 15, and includes a frame-shaped block having a predetermined thickness (length in the axial direction). As viewed in the axial direction, the outer shape of top cover 60 is the same as the outer shape of core assembly 40. An inclined side portion of core assembly 40 constituting the magnetic path surrounding magnet 32 is disposed along side portion 52 of bottom cover 50.

### <Core Assembly 40>

As shown in FIGS. 1 and 3 to 9, core assembly 40 forms drive unit 4 together with first shaft part 15, magnet 32, bottom cover 50, and top cover 60. Core assembly 40 forms a magnetic circuit that drives a reciprocating rotation of first shaft part 15 together with magnet 32.

Core assembly 40 includes coils 44 (44a and 44b), bobbins 46a and 46b around which coils 44 (44a and 44b) are wound, core body 400, and reference position holding part 48.

Core assembly 40 is formed in a rectangular frame-shaped block shape (specifically, a rectangular parallelepiped shape) in which magnetic poles of rod-shaped bodies 412a and 412b are disposed inside. Core assembly 40 is formed to surround the magnetic poles that are distal end portions of rod-shaped bodies 412a and 412b in a frame-shaped outer peripheral portion. Core assembly 40 is disposed, for example, in a rectangular region of a wall surface of wall portion 211 of base part 21 as viewed in the axial direction.

Core assembly 40 forms a single magnetic path that is folded back from a base end portion of each of rod-shaped bodies 412a and 412b sandwiching magnet 32 and extends to surround the magnetic poles of rod-shaped bodies 412a and 412b and magnet 32.

### <Coil Body (Coil and Bobbin)>

As shown in FIGS. 3, 6, 7, 9, and 13, coils 44 (44a and 44b) are wound around tubular bobbin main bodies 462 of bobbins 46a and 46b. The coil body consisting of coils 44a and 44b and bobbins 46a and 46b is externally fitted to the outer periphery of each of central portions of rod-shaped bodies 412a and 412b of first core 41. In this way, coils 44a and 44b are disposed to be adjacent to the magnetic poles of the distal end portions of rod-shaped bodies 412a and 412b. Coils 44a and 44b excite the magnetic poles of the distal end portions of rod-shaped bodies 412a and 412b by energization, and generate polarity corresponding to the energization direction in the magnetic poles.

The winding direction of coils 44a and 44b is set such that, in a case in which energization is performed, suitable magnetic fluxes that interact with magnet 32 are generated from one magnetic pole of the plurality of magnetic poles of first core 41 toward the other magnetic pole.

Terminal support portions 464 (see FIGS. 7, 9, and 13) that support terminals (terminal part) 49 are disposed on bobbin main bodies 462. Terminal support portions 464 support L-shaped terminals 49 shown in FIGS. 7 and 13 such that both end portions (other end portions 491 and one end portions 492) thereof protrude in the coil axial direction and the axial direction of second shaft part 14 (the same applies to first shaft part 15). Bobbin main bodies 462 position terminals 49 adjacent or close to coil 44a (or coil 44b) via the flange portion of bobbin main bodies 462 on which terminal support portions 464 are disposed to protrude. Terminals 49 are disposed at positions close to coils 44a and 44b in the coil axial direction, that is, in a direction along the diagonal line, for example.

Terminal support portions 464 are formed to protrude in the axial direction of first shaft part 15, and the protruding portions thereof are inserted into through-hole 66 of top cover 60. As a result, one end portions 492 of terminals 49 supported by terminal support portions 464 are inserted through top cover 60 and are connected to a wiring line of board (circuit board) 72 via a through-hole of board 72 (see FIGS. 2 and 7). Other end portions 492 are connected to coil wires constituting coils 44.

### <Core Body 400>

Core body 400 is a part of core assembly 40, is disposed to surround magnet 32, and has a magnetic path through which magnetic fluxes flow. Core body 400 forms the magnetic circuit together with coils 44 (44a and 44b) and reference position holding part 48.

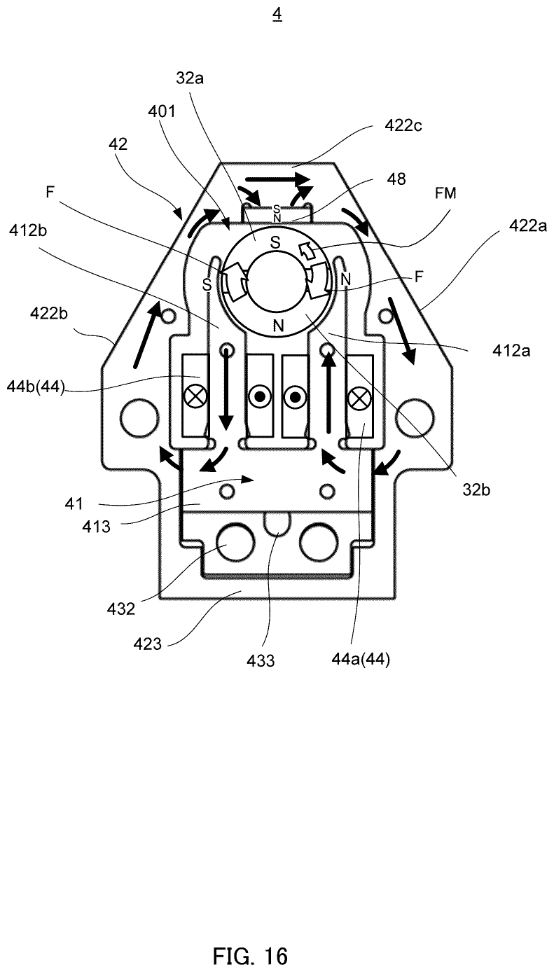

Core body 400 is formed by connecting a plurality of magnetic poles provided at the distal end portions of rod-shaped bodies 412a and 412b and facing magnet 32 to one another via a frame-shaped magnetic path that is disposed to surround magnet 32. Core body 400 has a shape in which the magnetic fluxes flow from one magnetic pole to the other magnetic pole in one direction of the magnetic poles of rod-shaped bodies 412a and 412b (see FIG. 16). In core body 400, the magnetic flux generated in a case in which coils 44 are energized passes between the magnetic poles at the distal ends of the plurality of rod-shaped bodies 412a and 412b.

Specifically, as shown in FIGS. 10 and 11, core body 400 integrally includes first core 41 having rod-shaped bodies 412a and 412b in parallel, and second core 42 connected to first core 41 and including the magnetic path that connects the base end portions of the plurality of rod-shaped bodies 412a and 412b. Second core 42 is connected to the base end portions of the plurality of rod-shaped bodies 412a and 412b to form the magnetic path that surrounds the magnetic poles and magnet 32 in the radial direction (direction orthogonal to the axis). Second core 42 is a frame-shaped magnetic material. Rod-shaped bodies 412a and 412b are rod-shaped magnetic materials.

First core 41 and second core 42 are, for example, laminated cores formed by laminating electromagnetic steel plates (laminated members) such as silicon steel plates.

By forming core body 400 in a laminated structure, first core 41 and second core 42 having a complicated shape can be formed at a low cost.

### <First Core 41>

In first core (also referred to as a “magnetic pole core”) 41, connecting side portion 413 that extends perpendicular to the extending direction of rod-shaped bodies 412a and 412b is connected to the base end portions of the plurality of rod-shaped bodies 412a and 412b having the magnetic poles facing each other at the distal end portions. Rod-shaped bodies 412a and 412b are disposed on bottom cover 50 along diagonal line DL and are symmetrically disposed with respect to diagonal line DL. Therefore, rod-shaped bodies 412a and 412b are disposed to be inclined with respect to both the Z direction and the Y direction.

First core 41 is formed in a C-shape (U-shape) by rod-shaped bodies 412a and 412b and connecting side portion 413, and step portion 414 that protrudes in a direction away from the magnetic poles is formed on a bottom surface (surface on the X direction side) portion of connecting side portion 413.

The magnetic poles of the distal end portions of rod-shaped bodies 412a and 412b are curved surfaces that are formed in an arc shape and face each other on the side surface portions of the respective distal end portions. The curved surfaces of the magnetic poles are formed to be curved to correspond to the outer peripheral shape of magnet 32, that is, along the outer peripheral surface of magnet 32, and face the outer peripheral surface of magnet 32 in a direction orthogonal to the axial direction. In addition, the magnetic poles of the distal end portions of rod-shaped bodies 412a and 412b are disposed such that the curved surfaces of the magnetic poles face each other, for example, in a direction orthogonal to the extending direction of rod-shaped bodies 412a and 412b. Since coils 44 are disposed on rod-shaped bodies 412a and 412b, coils 44 are obliquely disposed along diagonal line DL and can ensure a suitable length.

Rod-shaped bodies 412a and 412b have, for example, an outer shape dimension that allows bobbins 46a and 46b to externally fit to the rod-shaped bodies from the distal end side. As a result, bobbins 46a and 46b can be externally fitted from the distal end portion side of rod-shaped bodies 412a and 412b. By external fitting of bobbins 46a and 46b, coils 44a and 44b can be positioned to surround rod-shaped bodies 412a and 412b.

Connecting side portion 413 is disposed to be connected to rod-shaped bodies 412a and 412b at base end portions of rod-shaped bodies 412a and 412b, to extend in a direction orthogonal to the parallel direction of rod-shaped bodies 412a and 412b.

Connecting side portion 413 is attached to second core 42 to be stacked on second core 42 in a state in which the bottom surface thereof is in close contact with second core 42 in the axial direction together with step portion 414.

Fixing holes 432 and positioning hole 433 for fixing first core 41 and second core 42 and for positioning core body 400 with respect to bottom cover 50 are formed in step portion 414.

Fixing holes 432 fixe first core 41 and second core 42 to each other, and are formed to be in communication between first core 41 and second core 42 in the axial direction.

Fastening members 19 are inserted into fixing holes 432 in step portion 414 and fixing holes 432 in second core 42, whereby first core 41 is fastened to second core 42. First core 41 and second core 42 are integrally joined to each other by the lower surfaces of connecting side portion 413 and step portion 414 of first core 41 being in surface contact with the inner bottom surface of second core 42.

Positioning hole 433 communicates with positioning hole 57 in bottom cover 50, and pin 37 is inserted into positioning hole 433, whereby positioning can be performed in a case of assembling first core 41, second core 42, and bottom cover 50.

### <Second Core 42>

Second core 42 is a frame-shaped body that forms the magnetic path that is disposed to surround the magnetic poles of the distal end portions of rod-shaped bodies 412a and 412b and magnet 32 from four sides together with first core 41.

Second core 42 is formed in a trapezoidal frame shape having a pair of inclined side portions 422a and 422b and top side portion 422c such that its portion surrounding first shaft part 15 is not rectangular.

Under the assumption that second core 42 is viewed in the axial direction and top side portion 422c extends in the left-right direction, second core 42 has a shape in which inclined side portions 422a and 422b are inclined in a direction in which, from both end portions of top side portion 422c extending in the left-right direction, the end portions thereof are spaced apart from each other in the left-right direction and are arranged in the left-right direction. In second core 42, bottom side portion 423 parallel to top side portion 422c that partitions the frame portion is provided to extend between the end portions of inclined side portions 422a and 422b spaced apart from each other. Therefore, second core 42 is a so-called isosceles trapezoidal frame body that is narrowed toward one side.

As a result, the magnetic path formed by the frame body of second core 42 has a shape that is narrowed toward one side while surrounding first shaft part 15 in the radial direction of the shaft. Therefore, even in a case in which the insertion portion (opening portion 53) of rectangular bottom cover 50 for insertion of the shaft part (first shaft part 15) is irregularly shifted from the center of the surface and is positioned in the vicinity of corner portion 510 formed by side portions 52 and 54, second core 42 can be disposed to surround first shaft part 15 in the isosceles trapezoidal portion without protruding from the region of the rectangular bottom cover 50.

Specifically, inclined side portion 422a extends along side portion 52, and inclined side portion 422b extends on the surface of bottom cover 50 on the center side of side portion 54. As a result, the isosceles trapezoidal portion of second core 42 can surround first shaft part 15 without protruding from the region of bottom cover 50 beyond side portions 52 and 54.

As shown by a phantom line in FIG. 12, inclined side portion 422a includes an inclined portion overlapping side portion 52 and an end portion that is an end portion of the inclined portion and is a linear portion that is parallel to rod-shaped body 412b and is connected to bottom side portion 423.

In addition, similarly, as shown by a phantom line in FIG. 12, inclined side portion 422b includes an inclined portion having a shape that is line-symmetrical to inclined side portion 422a in second core 42 and an end portion that is an end portion of the inclined portion and is a linear portion that is parallel to rod-shaped body 412b and the linear portion of inclined side portion 422a and is connected to bottom side portion 423.

Bottom side portion 423 has a shape in which an inner wall portion is cut out in a recessed shape. The recessed inside of bottom side portion 423 communicates with space 401 of the second core. Connecting side portion 413 and step portion 414 of first core 41 are placed on inner bottom surface 424 inside recessed bottom side portion 423, whereby first core 41 is joined to second core 42.

First core 41 is disposed inside bottom side portion 423, that is, inside second core 42, and core body 400 that surrounds the magnetic poles at the distal ends of rod-shaped bodies 412a and 412b and the periphery of magnet 32 is formed. Core body 400 has a configuration in which the magnetic path via which the magnetic fluxes pass through the magnetic poles is formed in a case in which coils 44a and 44b are energized.

One (more specifically, inclined side portion 422b) of inclined side portions 422a and 422b is disposed to overlap side portion (upper side portion) 2111 of wall portion 211 to which drive unit 4 is attached.

Inclined side portions 422a and 422b and top side portion 422c are disposed to surround first shaft part 15 disposed in the vicinity of corner portion 510 of bottom cover 50.

A position of an end surface of second core 42 in the axial direction is a position coplanar with an end surface of first core 41 in the axial direction. Second core 42 is fixed in a state of being sandwiched between bottom cover 50 and top cover 60 via fastening members (pin member) 18 inserted (for example, internally fit) into attachment holes (fastening holes) 431 provided in both of inclined side portions 422a and 422b.

In addition, positioning hole 433 of second core 42 communicates with positioning hole 433 of first core 41 and positioning hole 57 of bottom cover 50. Pin 37 is inserted into positioning hole 433 and positioning hole 57. In core assembly 40, pin 37 is in a state of being inserted in the axial direction in a connection portion between the base end portions of rod-shaped bodies 412a and 412b and the frame-shaped portion from bottom cover 50 side to a central portion (positioning hole 433 portion of first core 41) (see FIG. 6). Pin 37 may be fixed to bottom cover 50 by being inserted into bottom cover 50. Pin 37 is inserted into core assembly 40 at a position that overlaps terminals 49 on one end portion 152 side of the first shaft part (shaft part) 15 as seen in a plane orthogonal to the axial direction (see FIG. 9) and that is spaced from terminals 49 when viewed in the direction orthogonal to the axial direction (see FIG. 6).

In core assembly 40, terminals 49 are disposed at a position overlapping pin 37 in the axial direction of first shaft part 15 when viewed in the plane orthogonal to the axial direction, as illustrated in FIG. 9. Terminals 49 are connected to coils 44a and 44b disposed at the middle portions of rod-shaped bodies 412a and 412b, the arrangement orientation of which is determined to be orthogonal to the axial direction.

That is, terminals 49 are disposed at a position on an extension line of the extending direction of pin 37 in core assembly 40 and are connected to coils 44a and 44b on the base end portion side of coils 44a and 44b along diagonal line DL (see FIG. 9) that is a direction orthogonal to the axial direction. In addition, terminals 49 are connected to board 72 of top cover 60 at a portion extending in the axial direction (one end portion 152 side of first shaft part 15).

According to this configuration, which is not a structure in which terminals 49 are disposed to avoid a position overlapping pin 37 in the axial direction (direction parallel to the axial direction of the shaft part and the extending direction of pin 37) in core assembly 40, the coil length does not become short. For example, since core assembly 40 is disposed in a limited space with respect to attachment surface portion 50, terminals 49 are moved to coils 44a and 44b side in a case in which terminals 49 are moved in a direction orthogonal to the axial direction for the position avoiding the overlapping position. In this case, the coil length of coils 44a and 44b is shortened in a direction along diagonal line DL, and terminals 49 can be shifted in the same direction in accordance with this configuration. On the other hand, in rotary reciprocating drive actuator 1, it is not necessary to shorten the coil length of coils 44a and 44b in a direction along diagonal line DL to shift the terminals in the same direction such that terminals 49 are positioned at a position avoiding the position overlapping pin 37 in the axial direction. In rotary reciprocating drive actuator 1, the coil length can be secured, and it is thus possible to perform the rotation driving at a high torque, to achieve the high amplitude.

The attachment holes of bottom cover 50 and top cover 60 are disposed to be continuous with attachment holes 431 in the axial direction, and fastening members 18 are inserted into attachment holes 431 and the attachment holes of bottom cover 50 and top cover 60.

Reference position holding part 48 is attached to second core 42 at a portion that is at the center of the extending direction and faces magnet 32.

In a state in which drive unit 4 is assembled, first shaft part 15 is inserted into a space surrounded by the magnetic poles, and magnet 32 is disposed together with first shaft part 15. The magnetic poles of magnet 32 face each other at an accurate position with air gap G being interposed therebetween.

### <Reference Position Holding Part 48>

Reference position holding part 48 generates a magnetic attraction force between magnet 32 by using a magnet (permanent magnet) with the magnetic pole facing toward magnet 32, and attracts magnet 32. That is, reference position holding part 48, together with rod-shaped bodies 412a and 412b, forms a magnetic spring between the reference position holding part and magnet 32. By the magnetic spring, in a normal state (non-energization state) in which coils 44a and 44b are not energized, the rotation angle position of magnet 32, that is, the rotation angle position of first shaft part 15 is held at a neutral position.

The neutral position is a reference position of the reciprocating rotation operation of magnet 32, that is, a center position of the reciprocating rotation (swing), and is a position at which the same rotation angle is obtained in a case of rotating left and right around the shaft in a case of reciprocating rotation. The neutral position is also referred to as a default position. In a case in which magnet 32 is held at the neutral position, magnetic-pole switching portion (boundary portion between S pole 32a and N pole 32b) 32c of magnet 32 faces the magnetic poles of rod-shaped bodies 412a and 412b.

In addition, the attachment posture of mirror part 11 can be adjusted with reference to the state in which magnet 32 is at the neutral position. Reference position holding part 48 may be composed of a magnetic material that generates a magnetic attraction force with magnet 32.

In a state in which rotary reciprocating drive actuator 1 is assembled, reference position holding part 48 mainly shown in FIGS. 3, 6, 7, 9, 13, 16, and 17 is incorporated into core assembly 40 to face magnet 32 via air gap G in between. Reference position holding part 48 is attached to, for example, recessed portion 422d formed in top side portion 422c of second core 42, in a posture in which the magnetic pole faces magnet 32.

### <Magnet 32>

Magnet 32 is a ring-shaped magnet in which S pole 32a and N pole 32b (polarity may be reversed) are alternately disposed in the circumferential direction. Magnet 32 is attached to the peripheral surface of first shaft part 15 such that magnet 32 is positioned in space 401 (see FIG. 12) surrounded by the magnetic poles of core body 400 in a state in which rotary reciprocating drive actuator 1 is assembled.

Magnet 32 is fixed to surround the outer periphery of first shaft part 15. Here, magnet 32 is firmly fixed to the central portion of first shaft part 15. Magnet 32 is firmly fixed to first shaft part 15 by applying an adhesive to the entire portion that is externally fitted to first shaft part 15, for example. In addition, depressed portion 153 (see FIGS. 6 and 13) is formed at the middle portion of first shaft part 15 to which magnet 32 is fitted. Depressed portion 153 collects (releases) the adhesive applied between magnet 32 and first shaft part 15 and prevents the adhesive from leaking out of the application region.

In the present embodiment, magnet 32 is magnetized to have different polarities with a plane along the axial direction of first shaft part 15 as a boundary. That is, magnet 32 is a two-pole magnet that is magnetized to be divided into two equal parts between S pole 32a and N pole 32b. The number of magnetic poles of magnet 32 (two in the present embodiment) is equal to the number of magnetic poles of core body 400. Note that magnet 32 may be magnetized to have two or more poles depending on the amplitude at the time of movement. In this case, the magnetic poles of core body 400 are provided to correspond to the magnetic poles of magnet 32.

In magnet 32, the polarities are switched at “magnetic-pole switching portions” that are boundary portion 32c between S pole 32a and N pole 32b. Magnetic-pole switching portions 32c are formed in one end surface of magnet 32 in a groove shape that extends through the axial center. Magnetic-pole switching portions 32c face the magnetic poles respectively in a case in which magnet 32 is held at the neutral position.

In a case in which magnetic-pole switching portions 32c are formed in a groove shape, the positional relationship of each component fixed to first shaft part 15 can be adjusted with the groove of magnetic-pole switching portions 32c as a reference in a case of assembly, maintenance, or the like of rotary reciprocating drive actuator 1. In particular, the position (posture) of mirror part 11 with respect to first shaft part 15 can be suitably and accurately defined according to the position of magnetic-pole switching portions 32c of magnet 32. For example, the rotation of first shaft part 15 around the shaft can be restricted by bringing a jig into contact with the groove in the axial direction and fitting a protrusion of the jig into the groove. As a result, the rotation of first shaft part 15 can be restricted at a desired angle position suitable for attaching other components to first shaft part 15, and the reference position for attaching the other components can be defined. In particular, the angle adjustment with respect to the magnetic poles of the mirror 32 requires accuracy, but the highly accurate angle adjustment can also be easily realized.

In the neutral position, magnetic-pole switching portions 32c of magnet 32 face the magnetic poles, so that drive unit 4 can generate a maximum torque and stably drive movable body 10.

Further, by configuring magnet 32 with a two-pole magnet, the magnet cooperates with core body 400 to easily drive a movable object at a high amplitude, to improve the driving performance. That is, mirror part 11 that is a movable object can be driven at a wide angle. In the embodiment, a case has been described in which magnet 32 has a pair of magnetic-pole switching portions 32c, but two or more pairs of magnetic-pole switching portions may be provided.

### <Bottom Cover 50 and Top Cover 60>

It is preferable that bottom cover 50 and top cover 60 shown in FIGS. 1 to 3, 5 to 8, 13, and 17 be formed from an electrically conductive material having non-magnetic properties and high electrical conductivity, and in this case, bottom cover 50 and top cover 60 function as an electromagnetic shield.

Bottom cover 50 and top cover 60 are particularly disposed on both sides of core assembly 40 in the axial direction (thickness direction) as shown in FIGS. 3 and 5 to 8, and close core assembly 40 in the axial direction.

Bottom cover 50 and top cover 60 can suppress the incidence of noise to core assembly 40 and the emission of noise from core body 400 to the outside.

Bottom cover 50 and top cover 60 are formed of, for example, a non-magnetic material having electrical conductivity and high thermal conductivity, such as an aluminum alloy. The aluminum alloy has high design freedom, and desired rigidity can be easily imparted to bottom cover 50 and top cover 60.

In addition, bottom cover 50 and top cover 60 sandwich core assembly 40 in the axial direction and fix fastening members 18 by inserting fastening members 18 (for example, by screwing). In top cover 60, fixing holes into which fastening members 18 are inserted are formed in counterbore portion 64.

Bottom cover 50 is attached so as to overlap the outer surface of wall portion 211. Bottom cover 50 is formed in a rectangular plate shape corresponding to the outer shape of wall portion 211. Bottom cover 50 has cover main body 51 having a rectangular plate shape, and in cover main body 51, opening portion 53 into which first shaft part 15 is inserted via bearing 24 is formed in the vicinity of corner portion 510 where side portions 52 and 54 are orthogonal to each other. Opening portion 53 is disposed at a position in communication with insertion hole 211a of wall portion 211. Opening portion 53 is formed at a position shifted from the center of the surface to corner portion 510 side on the outer surface (one surface) of bottom cover 50.

Bearing 24 is disposed to be internally fit from core assembly 40 side to opening portion 53 of cover main body 51. Bearing 24 has flange 244 on the outer peripheral surface, and flange 244 is engaged with a step (counterbore portion) of opening portion 53. Flange 244 prevents bearing 24 from coming off from the attachment surface side of bottom cover 50 to base part 21. As described above, bearing 24 restricts its movement to the axially outer side of bottom cover 50 by flange 244 being engaged with the step of opening portion 53, that is, being engaged with bottom cover 50 from the inside. First shaft part 15 inserted into bearing 24 is disposed to protrude from a predetermined position of bottom cover 50 in drive unit 4 to connect mirror part 11. The predetermined position is a position shifted from the center of the outer surface of bottom cover 50 to corner portion 510 side as described above, and is a position that is eccentric from the center toward the corner portion in bottom cover 50.

As shown in FIGS. 8 and 13, cover main body 51 of bottom cover 50 is provided with fixing holes 55, attachment holes 56 for fixation to base part 21, positioning hole 57, core positioning projections 58, and fixing holes 59.

Fixing holes 55 fix fastening members 19 inserted into fixing holes 432 of core assembly 40. As a result, core assembly 40 is fixed to bottom cover 50. Fastening members 18 engaged with top cover 60, inserted through top cover 60, and inserted through core assembly 40 are fastened to fixing holes 59. Top cover 60, core assembly 40, and bottom cover 50 are integrally attached to each other by fastening members 18.

Attachment holes 56 fix bottom cover 50 and drive unit 4 to wall portion 211. Attachment holes 56 are formed at positions on opposite sides of core assembly 40 in a direction orthogonal to the extending direction of rod-shaped bodies 412a and 412b. Attachment holes 56 are disposed at positions that avoid core assembly 40 (core body 400) at positions on another diagonal line (another oblique line) extending in a direction intersecting diagonal line DL in bottom cover 50.

Attachment holes 56 are fixed to fixing holes 211b (see FIG. 4) of wall portion 211 via fastening members 16, and bottom cover 50 and drive unit 4 are fixed to base part 21. Drive unit 4 is fixed to wall portion 211 in a state in which first shaft part 15 is inserted into insertion hole 211a in wall portion 211.

Opening portion 53, fixing holes 55, attachment holes 56, positioning hole 57, fixing holes 59, and the holes in communication with these holes are formed in parallel to the axial direction of first shaft part 15. Since the assembly of each part including drive unit 4 and base part 21 by fastening members 16, 18, and 19 can be performed in one direction of the axial direction, the improvement in the assembly efficiency can be achieved.

In addition, as shown in FIGS. 6 and 8, positioning projection portion 588 that protrudes in a tubular shape is provided on an edge portion of opening portion 53 on the back surface side of cover main body 51 of bottom cover 50. Positioning projection portion 588 is internally fit to insertion hole 211a of base part 21. As a result, positioning projection portion 588 can be internally fit to insertion hole 211a, bottom cover 50 can be installed on wall portion 211 in a positioned state, and then bottom cover 50 can be attached to wall portion 211.

Core positioning projections 58 shown in FIG. 13 are fitted to core assembly 40 to position core assembly 40 in a case of combining bottom cover 50 and core assembly 40. Specifically, core positioning projections 58 are provided to protrude from the edge portion of opening portion 53 on the front surface side of cover main body 51 in the axial direction from positions facing each other across opening portion 53.

Core positioning projections 58 are inserted between rod-shaped bodies 412a and 412b and inclined side portions 422a and 422b to be fitted to core assembly 40 and to position the attachment position of core assembly 40 with respect to bottom cover 50.

In bottom cover 50, core assembly 40, and top cover 60, preload springs 82 and 84 as the preload parts that apply, from the inside of drive unit 4 in the axial direction, a constant pressure preload to bearings 24 and 26 into which first shaft part 15 is inserted are disposed.

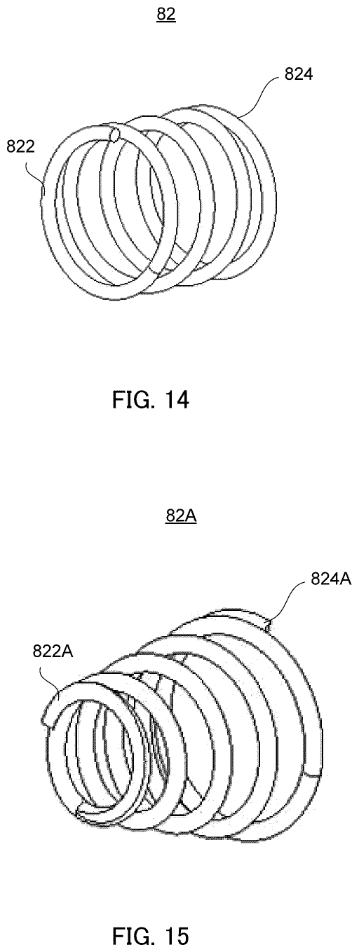

FIG. 14 is an enlarged view of a preload part of the rotary reciprocating drive actuator. Preload spring 82 that is an example of the preload part shown in the figure is a coil spring and is formed in the same manner as preload spring 84. Preload spring 82 is a cylindrical coil spring in which both end portions 822 and 824 spaced apart in a predetermined length direction have the same diameter. Preload spring 82 is disposed between magnet 32 and bearing 24 and on the outer periphery of first shaft part 15 in a state of being contracted in the axial direction, and applies the constant pressure preload to bearing 24 to bias bearing 24 in the axial direction. Preload spring 82 presses bearing 24 from the inside of drive unit 4 to other end portion 154 side by applying the preload. In other words, preload spring 82 presses bearing 24 from the inside of drive unit 4 to other end portion 144 side of the entire movable body including second shaft part 14 by applying the preload.

As shown in FIGS. 3 and 6, preload spring 82 and stopper 86 are externally fitted to first shaft part 15 inserted in bearing 24, and preload spring 82 presses bearing 24 via stopper 86.

By applying the constant pressure preload to bearing (particularly, the ball bearing) 24 by preload spring 82, the expansion and contraction of first shaft part 15 due to the temperature difference between first shaft part 15 and base part 21 during the load fluctuation or the rotation can be absorbed. As a result, since the vibration of first shaft part 15 in the axial direction can be prevented by the constant pressure preload mechanism in which the preload application position appropriately fluctuates, first shaft part 15 can be driven at high speed with low vibration as compared with the constant position preload.

In addition, since the low frictional property and the high reliability of the rotation driving of first shaft part 15 are maintained, stable driving can be realized.

Stopper 86 restricts a deformation region of preload spring (coil spring) 82 in the axial direction in a case in which preload spring 82 presses bearing 24 from the body portion side of drive unit 4 to the wall portion 212 side (the other end portion side), and prevents preload spring 82 from being excessively compressed in the axial direction. In other words, stopper 86 prevents the preload spring (coil spring) 82 that presses bearing 24 from the body portion side of drive unit 4 to the other end portion side from having a solid length equal to or less than the solid length.

Stopper 86 is disposed between preload spring 82 and bearing 24. Stopper 86 has a depressed portion that is a tubular space into which a spring, which is preload spring 82, is inserted between the stopper and first shaft part 15. One end portion side of the preload spring (coil spring) 82 is accommodated in the depressed portion, and preload spring 82 presses bearing 24 via the depressed portion of stopper 86.

In a case in which preload spring 82 is contracted, preload spring 82 is deformed in the axial direction in the depressed portion of stopper 86. In the depressed portion of stopper 86, preload spring 82 is allowed to be deformed until the turns of the coil constituting the coil spring make close contact with each other in the axial direction, and further deformation is restricted by stopper 86. As described above, stopper 86 restricts the turns of the coils adjacent to each other in the axial direction in preload spring 82 from being in close contact with each other at the solid length or a lesser length.

In drive unit 4, first shaft part 15 is prevented from being excessively pushed into stopper 86, preload spring 82 does not reach its solid length or a lesser length, and it is possible to prevent a malfunction (including a failure) of preload spring 82 due to the excessive pushing of first shaft part 15. In a configuration in which the stepped shaft is used as first shaft part 15, stopper 86 prevents preload spring 82 from being deformed outward in a case in which preload spring 82 presses bearing 24 via stopper 86.

Preload spring 82 may be conical coil spring 82A having a conical shape as shown in FIG. 15. Conical coil spring 82A has different diameters of both end portions 822A and 824A spaced apart in the axial direction. In conical coil spring 82A, in a case in which the turns of the coil constituting conical coil spring 82A move in the axial direction, the turns overlap with each other in the radial direction and are in close contact with each other without overlapping with each other in the axial direction, as compared with the cylindrical coil spring. Therefore, even in a case in which conical coil spring 82A is contracted, the turns of the coil are not in close contact with each other in the axial direction, and the solid height of conical coil spring 82A is lower than that of the cylindrical coil spring. As a result, in a case in which rotary reciprocating drive actuator 1 has conical coil spring 82A, the length of drive unit 4 and rotary reciprocating drive actuator 1 in the axial direction can be shortened as compared with a case in which cylindrical preload spring 82 is used.

Top cover 60 and bottom cover 50 sandwich core assembly 40 from both sides in the axial direction and cover core assembly 40. Top cover 60 is integrally fixed by fastening members 18 to constitute drive unit 4.

Top cover 60 has cover main body 62 that covers the surface of core assembly 40 on the distal end side. Top cover 60 is configured as a covered cylindrical shape in which a peripheral wall portion is provided to protrude from an outer peripheral edge portion of cover main body 62 to core assembly 40 side.

Cover main body 62 has a shape corresponding to the outer shape of core assembly 40 as viewed in the axial direction, and is formed in a shape including a trapezoidal shape portion having inclined side portions. Cover main body 62 is provided with opening portion 63 and through-hole 66. Opening portion 63 is disposed in cover main body 62 to have the same axis as opening portion 53 of bottom cover 50 and bearing 22 of base part 21.

Bearing 26 into which first shaft part 15 is inserted is internally fit to opening portion 63 from the back surface side (core assembly 40 side). Opening portion 63 is provided with counterbore portion 64 (see FIG. 6) that is a step on the back surface side.

Terminals 49 are inserted into through-hole 66 via terminal support portions 464 of bobbins 46a and 46b.

Terminal support portions 464 of the coil body may be internally fit to through-hole 66. One end portions 492 of terminals 49 that protrude from terminal support portions 464 are connected to board 72, and power can be supplied to coils 44a and 44b via board 72 connected to a power supply part. The power supply part may be provided on board 72.

Positioning portions (boss portions 68 and arc-shaped boss portions 69) that are engaged with core assembly 40 in the axial direction to prevent rotation around the shaft and to be positioned is provided on the back surface of cover main body 62. The positioning portions (boss portions 68 and arc-shaped boss portions 69) are provided on core assembly 40 side (one end side) and are fitted to core assembly 40.

Boss portions 68 enter the inside of recessed bottom side portion 423 of core assembly 40 and are engaged with inner corner portion 4231 (see FIG. 7) to restrict the relative movement of top cover 60 and core assembly 40 around first shaft part 15.

Arc-shaped boss portions 69 are fitted to a gap of core assembly 40, that is, core groove portion 402 (see FIG. 7) that is a gap between inclined side portions 422a and 422b and the magnetic poles of rod-shaped bodies 412a and 412b. As a result, the relative movement of top cover 60 and core assembly 40 in the radial direction around the axis of first shaft part 15 is restricted.

As described above, cover main body 62 of top cover 60 can be engaged with the upper surface of core assembly 40 by boss portions 68 and arc-shaped boss portions 69. As a result, the positioning of top cover 60 and core assembly 40 and the accurate joining thereof can be easily realized.

Core assembly 40 to which top cover 60 is attached is positioned and fixed to bottom cover 50 or a jig (not shown) via pin 37 in performing the attachment work. The jig is for attaching top cover 60 to core assembly 40.

Top cover 60 is fitted and positioned in an upper portion of core assembly 40 where pin 37 is not present by boss portion 68 and arc-shaped boss portions 69. In this configuration, pin 37 extends to the top cover side and does not pass through top cover 60. Therefore, board 72 such as a relay board can be disposed above pin 37 in top cover 60 (see FIG. 6). In addition, terminals 49 can be disposed between board 72 and pin 37. With this arrangement, in a case of attaching top cover 60 to core assembly 40 in the axial direction, terminals 49 can be connected to board 72 in the axial direction.

Bearing 26 rotatably supports first shaft part 15 to be inserted into top cover 60. Bearing 26 has flange 264 on the outer periphery, and flange 264 is engaged with counterbore portion 64 of opening portion 63, that is, is engaged with the back surface of top cover 60. As a result, the movement of bearing 26 to the axially outer side from the back side of wall portion 211 in top cover 60 is restricted.

Bearing 26, together with bearing 24 provided in bottom cover 50, supports first shaft part 15 that rotates about the same axial center as second shaft part 14.

Bearing 26 is biased to the opening portion 63 side by preload spring 84, and the constant pressure preload is applied in the same manner as preload spring 82 via stopper 88. Preload spring 84 is the same as preload spring 82 and is the cylindrical coil spring shown in FIG. 14.

As described above, in drive unit 4, the constant pressure preload is applied to bias bearings 24 and 26 to opposite outer sides in the axial direction of first shaft part 15 with magnet 32 interposed therebetween.

In addition, as preload spring 84, for example, conical coil spring 82A shown in FIG. 15 may be used. By using conical coil spring 82A instead of preload spring 84, the solid length is shortened as compared with a case in which cylindrical preload spring 84 is used, and drive unit 4 and rotary reciprocating drive actuator 1 can be shortened in the axial direction.

The movement of movable body 10 to the other end side, that is, the right side in FIG. 3 with respect to base part 21 is restricted by the movement of first shaft part 15 to the right side being restricted by magnet 32 via preload spring 82 and stopper 86. In addition, the movement of movable body 10 to one end portion 152 side, that is, the left side in FIG. 3 with respect to base part 21 is restricted by the movement of second shaft part 14 to the left side being restricted by shaft movement restricting part 23 such as the E-ring that is externally fitted to second shaft part 14. With these movements restricted, movable body 10 does not come off from base part 21.

Rotary reciprocating drive actuator 1 is used in a state in which bottom portion 213 of base part 21 is installed on a product. A back surface of bottom portion 213 is installation surface 213a that comes into contact with the product in a case in which rotary reciprocating drive actuator 1 is installed on the product. Mirror part 11 reciprocally rotates around first shaft part 15 and second shaft part 14 that are parallel to installation surface 213a.

Since drive unit 4 is attached to and makes surface contact with wall portion 211 perpendicular to bottom portion 213, bottom cover 50 is disposed to stand up perpendicular to bottom portion 213 of base part 21 serving as installation surface 213a.

First shaft part 15 and second shaft part 14 are disposed on the same axis, and first shaft part 15 is rotatably disposed at a position spaced from installation surface 213a in a direction away from the center of the outer surface of wall portion 211 on the outer surface of bottom cover 50 or wall portion 211. The position spaced from installation surface 213a is a position (eccentrically offset position) shifted from the center of the outer surface of wall portion 211, and is a position in the vicinity of corner portion 210 defined by side portions 2111 and 2112, that is, a position in the vicinity of corner portion 510 of bottom cover 50. [Magnetic Circuit Configuration of Rotary Reciprocating Drive Actuator 1]

FIG. 16 is a diagram showing an operation of the rotary reciprocating drive actuator by the magnetic circuit of the rotary reciprocating drive actuator according to the present embodiment.

In a case in which coils 44a and 44b are energized, first core 41 and second core 42 including rod-shaped bodies 412a and 412b are excited, and polarities corresponding to the energization direction are generated in the magnetic poles. As a result, a magnetic force (attractive force and repulsive force) is generated between the magnetic poles of the distal end portions of rod-shaped bodies 412a and 412b and magnet 32, and mirror part 11 is reciprocally rotated via first shaft part 15 by reciprocally rotating magnet 32.

The operation will be described in detail. In rotary reciprocating drive actuator 1, in a non-energization state of coils 44, magnet 32 is positioned at an operation reference position by the magnetic attraction force, that is, the magnetic spring between reference position holding part 48 and magnet 32.

In a normal state, that is, at the operation reference position, one of magnetic poles (S pole 32a and N pole 32b) of magnet 32 is attracted to reference position holding part 48, and magnetic-pole switching portion 32c is positioned at a position facing the center position of the magnetic poles of rod-shaped bodies 412a and 412b.

As shown in FIG. 16, for example, in a configuration in which reference position holding part 48 is magnetized to the N pole on the facing surface facing magnet 32, the magnetic spring torque (indicated by an arrow FM) is generated to rotate magnet 32 to attract the S pole (magnetic pole) 32a of magnet 32.

In a case in which magnet 32 is at the operation reference position in the normal state, movable body 10 can be driven in a desired rotation direction by the excitation of coils 44a and 44b corresponding to the energization direction of coils 44a and 44b, and the maximization of the torque can be realized.

In a case in which coils 44a and 44b are energized, core assembly 40 is excited, and polarities corresponding to the energization direction are generated in the magnetic poles. For example, as shown in FIG. 16, in a case in which coils 44 are energized, the magnetic flux is generated in core body 400, and the magnetic pole of rod-shaped body 412a is the N pole and the magnetic pole of rod-shaped body 412b is the S pole.

As a result, the magnetic pole of rod-shaped body 412a magnetized to the N pole attracts S pole 32a of magnet 32, and the magnetic pole of rod-shaped body 412b magnetized to the S pole attracts N pole 32b of magnet 32. Then, the torque in the F direction is generated around the shaft of first shaft part 15 in magnet 32, and magnet 32 rotates in the F direction. Accompanying this, first shaft part 15 also rotates in the F direction, and mirror part 11 fixed to first shaft part 15 also rotates in the F direction.

Next, in a case in which coils 44 are energized in the opposite direction, the flow of the magnetic flux generated in core body 400 is in the opposite direction to the direction shown in FIG. 16, and the magnetic pole of rod-shaped body 412a is the S pole and the magnetic pole of rod-shaped body 412b is the N pole. The magnetic pole magnetized to the S pole attracts N pole 32b of magnet 32, and the magnetic pole magnetized to the N pole attracts S pole 32a of magnet 32. Then, torque −F in the direction opposite to the F direction is generated around the shaft of first shaft part 15 in magnet 32, and magnet 32 rotates in the −F direction. Accompanying this, first shaft part 15 also rotates, and mirror part 11 fixed to first shaft part 15 also rotates in the direction opposite to the direction shown in FIG. 16. Rotary reciprocating drive actuator 1 drives a reciprocating rotation of mirror part 11 by repeating the above operation.

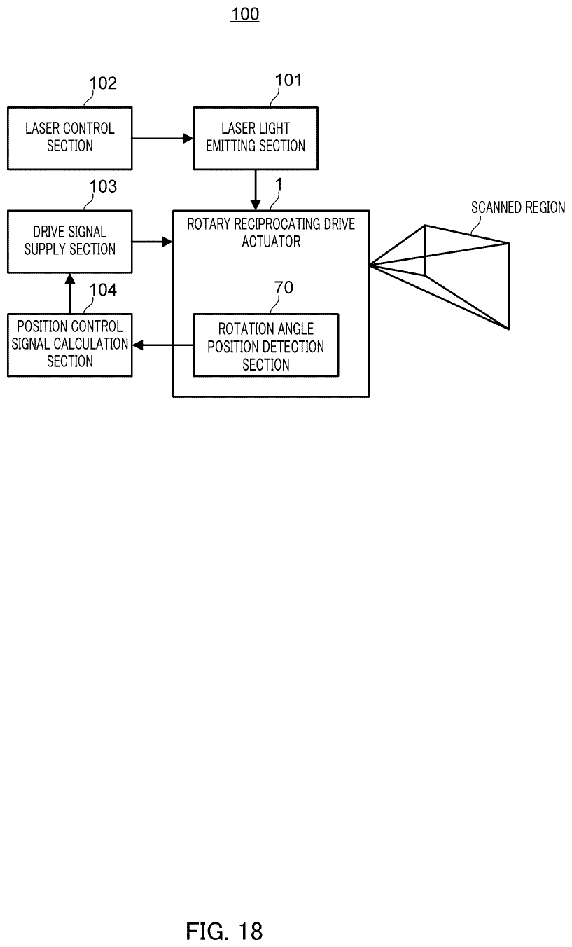

In practice, rotary reciprocating drive actuator 1 is driven by an alternating current wave input to coils 44 from the power supply part (corresponding to, for example, drive signal supply section 103 of FIG. 18). That is, the energization direction of coils 44 are periodically switched. In a case in which the energization direction is switched, magnet 32 is biased to return to the neutral position by the magnetic attraction force between reference position holding part 48 and magnet 32, that is, the restoring force of the magnetic spring (magnetic spring torque FM shown in FIG. 16 and the torque “-FM” in the opposite direction). As a result, the torque in the F direction and the torque in the direction (the −F direction) opposite to the F direction alternately act on first shaft part 15 (movable body 10) around the shaft. As a result, the reciprocating rotation of movable body 10 is driven.

Hereinafter, a driving principle of rotary reciprocating drive actuator 1 will be briefly described. In rotary reciprocating drive actuator 1 of the present embodiment, in a case in which the inertial moment of movable body 10 is J [kg·m²] and the spring constant in the torsional direction of the magnetic spring (rod-shaped bodies 412a and 412b, reference position holding part 48, and magnet 32) is Kₛₚ, movable body 10 vibrates at resonance frequency Fr [Hz] calculated by Equation 1 with respect to fixed body 20:

$$\begin{matrix}[ 1 ] & \\ Fr = \frac{1}{2 π} \sqrt{\frac{{K}_{sp}}{J}} & ( Equation 1 )\end{matrix}$$

Fr: Resonance frequency [Hz]
J: Inertial moment [kg·m²]
Kₛₚ: Spring constant [N·m/rad]

Since movable body 10 constitutes the mass part in the vibration model of the spring-mass system, in a case in which the alternating current wave having a frequency equal to the resonance frequency Fr of movable body 10 is input to coils 44a and 44b, movable body 10 is brought into a resonance state. That is, by inputting the alternating current wave having a frequency substantially equal to the resonance frequency Fr of movable body 10 to coils 44a and 44b from the power supply part, movable body 10 can be efficiently vibrated.

The equation of motion and the circuit equation representing the driving principle of rotary reciprocating drive actuator 1 are shown below. Rotary reciprocating drive actuator 1 is driven based on the equation of motion shown in Equation 2 and the circuit equation shown in Equation 3:

$$\begin{matrix}[ 2 ] & \\ J \frac{{d}^{2} θ ( t )}{{dt}^{2}} = {K}_{t} i ( t ) - {K}_{sp} θ ( t ) - D \frac{d θ ( t )}{dt} - {T}_{Loss} & ( Equation 2 )\end{matrix}$$

J: Inertial moment [kg·m²]
θ(t): Angle [rad]
Kₜ: Torque constant [N·m/A]
i(t): Current [A]
Kₛₚ: Spring constant [N·m/rad]
D: Damping coefficient [N·m/(rad/s)]
T_{Loss}: Load torque [N·m]

$$\begin{matrix}[ 3 ] & \\ e ( t ) = Ri ( t ) + L \frac{di ( t )}{dt} + {K}_{e} \frac{d θ ( t )}{dt} & ( Equation 3 )\end{matrix}$$

e(t): Voltage [V]
R: Resistance [Ω]
L: Inductance [H]
Kₑ: Counter electromotive force constant [V/(rad/s)]

That is, the inertial moment J [kg·m²], the rotation angle θ(t) [rad], the torque constant Kₜ [N·m/A], the current i(t) [A], the spring constant Kₛₚ [N·m/rad], the damping coefficient D [N·m/(rad/s)], the load torque T_{Loss} [N·m], and the like of movable body 10 in rotary reciprocating drive actuator 1 can be appropriately changed within a range in which Equation 2 is satisfied. Further, the voltage e(t)[V], the resistance R[Ω], the inductance L[H], and the counter electromotive force constant Kₑ[V/(rad/s)] can be appropriately changed within the range satisfying Equation 3.

As described above, in rotary reciprocating drive actuator 1, in a case in which coils 44a and 44b are energized by the alternating current wave corresponding to the resonance frequency Fr determined by the inertial moment J of movable body 10 and the spring constant Kₛₚ of the magnetic spring, an efficiently large vibration output can be obtained.

According to the rotary reciprocating drive actuator of the present embodiment, it is possible to drive a reciprocating rotation of mirror part 11 that is the movable object with increased torque generation efficiency of drive unit 4. In addition, heat is not easily transmitted to mirror part 11 that is the movable object, and the accuracy of the flatness of the reflecting surface of mirror part 11 can be ensured. In addition, the manufacturing properties are high, the assembly accuracy is high, and the movable object can be driven with a high amplitude even in a case of a large mirror.

Rotary reciprocating drive actuator 1 of the embodiment can perform the resonance driving, but can also perform the non-resonance driving. In addition, by increasing the damping coefficient by using a damping part, the ringing can also be suppressed.

In drive unit 4, core assembly 40 is fixed to the surface of rectangular bottom cover 50 to be positioned on the substantially diagonal line DL together with first shaft part 15. In addition, top cover 60 is attached to core assembly 40 to cover the inside of core assembly 40.

Bottom cover 50 is fixed to wall portion 211 to be in surface contact with and overlap wall portion 211 via fastening members 16 inserted into attachment holes 56 positioned on both sides of core assembly 40. Bottom cover 50 is attached to wall portion 211 such that side portions 52 and 54 of bottom cover 50 match side portions 2111 and 2112 of wall portion 211. Core assembly 40 is positioned on the substantially diagonal line DL on the outer surface of bottom cover 50 or is disposed along diagonal line DL.

Rod-shaped bodies 412a and 412b and coils 44 are disposed to be inclined with respect to side portion 52, 2111 corresponding to the upper side and installation surface 213a corresponding to the lower side. As a result, the coil length in the magnetic circuit can be designed to be longer as compared with a configuration in which first shaft part 15 is disposed at the center of wall portion 211 having a dimension width from installation surface 213a to side portions 52 and 2111.

Even in a case in which the coil length cannot be secured in any of the vertical direction and the horizontal direction of the product that is an attachment target portion, coils 44 can be disposed along diagonal line DL of bottom cover 50, so that the coil length can be secured.

Therefore, a high amplitude driving can be performed with a sufficient coil length to achieve a high torque output while achieving the reduction in height of rotary reciprocating drive actuator 1.

In addition, core assembly 40 and top cover 60 have a configuration that prevents rotation during attachment. With this configuration, the coil length can be maintained at a predetermined length (length at which a high torque output can be achieved) without extending pin 37 from bottom cover 50, so that a high torque can be output. Side portions 52 and 54 correspond to side portions 2111 and 2112 of wall portion 211. As a result, even in a case in which the position (insertion hole 211a) at which first shaft part 15 is inserted in wall portion 211 is shifted from the center of wall portion 211, core assembly 40 and core body 400 can be suitably installed in the same manner.

In addition, the shaft parts (first shaft part 15 and second shaft part 14) are disposed at corner portion 510 of bottom cover 50, that is, corner portion 210 of wall portion 211. Therefore, by employing, as a product upper surface” the upper surface (surface on an upward gradient side of the oblique magnetic circuit) of the magnetic circuit disposed obliquely along diagonal line DL, the magnetic path can be secured to achieve the reduction in height.

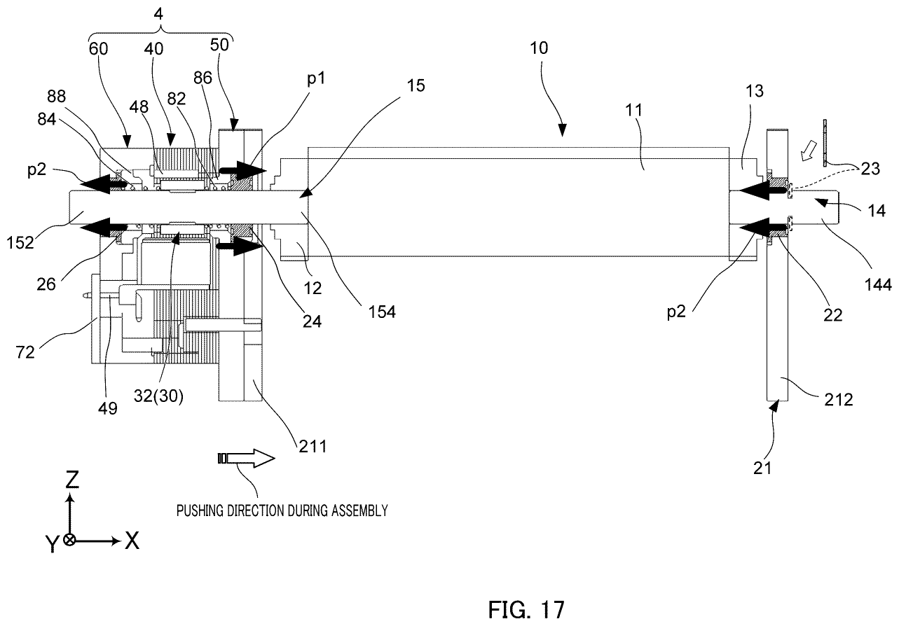

Here, in rotary reciprocating drive actuator 1 of the present embodiment, the constant pressure preload is applied to bearings 22, 24, and 26. A method of applying the constant pressure preload will be described with reference to FIG. 17.

FIG. 17 is a view for describing a method of applying a preload in the rotary reciprocating drive actuator. In rotary reciprocating drive actuator 1 shown in FIG. 17, first shaft part 15 and second shaft part 14 are inserted into bearings 22, 24, and 26 of base part 21 on which drive unit 4 is assembled, and shaft movement restricting part 23 is not attached.

In a case in which movable body 10 is attached to base part 21 to be rotatable while the preload is applied, first shaft part 15 and second shaft part 14 are in a state of being pulled toward second shaft part 14 against the biasing force of preload spring 82 in a state in which shaft movement restricting part 23 is not attached to second shaft part 14.

That is, in FIG. 17, first shaft part 15 and movable body 10 (including second shaft part 14) are in a state of being pushed to the right side (wall portion 212 side) with respect to base part 21.

In a case in which the protruding end of second shaft part 14 is pulled in the X direction, first shaft part 15 is pressed in the pressing direction during the assembly shown in FIG. 17, and in this state, preload spring 82 biases bearing 24 in the p1 direction. In this case, bearing 22 is also pressed in the same direction.

In this state, in a case in which shaft movement restricting part 23 is fitted to second shaft part 14, the movement of second shaft part 14 in the −X direction is restricted, and movable body 10 is fixed in a state of being pulled to second shaft part 14 side. As a result, a force to be restored acts on preload spring 82, and preload spring 82 presses bearing 24 in the p1 direction, but bearing 22 is subjected to a force in the p2 direction, and is brought to a state where the preload is applied.

In addition, a force to be restored also acts on deformed preload spring 82 as second shaft part 14 moves in the X direction, and a reaction force from magnet 32 is generated on first shaft part 15 in preload spring 82, and a biasing force in the direction of arrow p2 acts on bearing 26. As a result, the constant pressure preload is applied to each of bearings 22, 24, and 26 of rotary reciprocating drive actuator 1. As a result, the biasing force toward the one end portion side of second shaft part 14 is applied to bearing 22 by the preload part (preload spring 82) that applies the constant pressure preload to bearing 24.

In addition, in a case in which movable body 10 is assembled to base part 21, that is, between the pair of wall portions 211 and 212 in a state in which shaft movement restricting part 23 is detached, first shaft part 15 may be pulled to the distal end side (the drive unit 4 side and the left side on the paper surface of FIG. 17) in contrary. In this state, shaft movement restricting part 23 is externally fitted and fixed to second shaft part 14. As a result, preload spring 84 that applies the constant pressure preload to bearing 26 applies the constant pressure preload to bearing 26 and applies the constant pressure preload to bearing 22 of wall portion 212. As described above, first shaft part 15 suitably drives movable body 10 via bearings 22, 24, and 26 to prevent shaft runout during rotation and to suppress noise and vibration.

Rotary reciprocating drive actuator 1 of the present embodiment includes movable body 10 to which mirror part 11 is connected via the mirror holders (holders) 12 and 13 and that includes second shaft part 14. First shaft part 15 and annular magnet 32 fixed to first shaft part 15 are connected to movable body 10. Movable body 10 may have a configuration including first shaft part 15 and magnet 32. Rotary reciprocating drive actuator 1 includes core assembly 40 including: core body 400 that includes a plurality of magnetic poles facing each other on the outer periphery of magnet 32 and is disposed to surround magnet 32; and coils 44a and 44b disposed on core body 400.

Drive unit 4 has a configuration in which bottom cover 50 and top cover 60 are disposed to sandwich core assembly 40 in the axial direction, and first shaft part 15 to be inserted is rotatably supported by each of bearings 24 and 26.

In base part 21, wall portion 212 supports second shaft part 14 protruding from mirror part 11 such that second shaft part 14 is inserted into bearing (wall bearing) 22 of wall portion 212, so as to enable reciprocating rotation of support second shaft part 14. Drive unit 4 applies the preload to each of bearings 24 and 26 and bearing (wall bearing) 22 between magnet 32 and each of bearings 24 and 26 by the pair of preload springs 82 and 84 that are disposed to be externally fitted to first shaft part 15.

Since preload springs 82 and 84 are provided, even in a case in which the rotary reciprocating drive actuator is a cantilever type, the impact resistance and the vibration resistance can be ensured by bearing 22, and the improvement in the shaft runout accuracy of second shaft part 14 and the suppression of noise and vibration can be realized. In addition, it is not necessary to separately provide a preload biasing member in order to apply the preload to bearing 22, and the product size of the rotary reciprocating drive actuator or the device including the rotary reciprocating drive actuator itself can be reduced in height or reduced in size.

As described above, rotary reciprocating drive actuator 1 can generate a high torque to achieve a high amplitude and can be reduced in height.

In the conventional configuration (PTL 1), during assembly, it is desirable to fix the mirror part at a position where dimensions can be defined with reference to the rotary shaft, in order to ensure high accuracy of the mirror part and to output high torque since the rotation angle of the mirror part, which is the movable object, is important.

In contrast, according to the vibration actuator 1, assembly is easy, and an increased amplitude can be achieved by rotary driving at high torque.

### [Schematic Configuration of Scanner System]

FIG. 18 is a block diagram showing a main configuration of an example of scanner system 100 including the rotary reciprocating drive actuator.

Scanner system 100 shown in FIG. 18 includes laser light emitting section 101, laser control section 102, rotary reciprocating drive actuator 1, drive signal supply section 103, and position control signal calculation section 104.

In scanner system 100, the object is scanned using rotary reciprocating drive actuator 1 that can drive reciprocating rotation of mirror part 11 about one axis. In addition, rotary reciprocating drive actuator 1 includes an angle sensor section as rotation angle position detection section 70 that detects the angle of mirror part 11, that is, the rotation angle of first shaft part 15. The angle sensor section detects the rotation angle of movable body including magnet 32 and first shaft part 15. Rotary reciprocating drive actuator 1 can 10 control the movable body during driving, specifically, the rotation angle position and the rotation speed of mirror part 11 that is the movable object, via the controller or the like based on a detection result of the angle sensor section. Rotation angle position detection section 70 may be a sensor of any of a magnetic type or an optical type.

Laser control section 102 controls laser rays to be emitted by driving laser light emitting section 101. Laser light emitting section 101 is, for example, a laser diode (LD) that is a light source and a lens for focusing the output laser rays. The laser light from the light source is emitted to mirror part 11 of rotary reciprocating drive actuator 1 via the lens system.

Position control signal calculation section 104 generates and outputs a drive signal for controlling second shaft part 14 and first shaft part 15 (mirror part 11) such that second shaft part 14 and first shaft part 15 are at the target angle positions, with reference to the actual angle positions of second shaft part 14 and first shaft part 15 (mirror part 11) acquired by rotation angle position detection section 70 and the target angle positions. For example, position control signal calculation section 104 generates a position control signal based on the acquired actual angle positions of second shaft part 14 and first shaft part 15 (mirror part 11) and a signal indicating the target angle positions converted by using sawtooth waveform data or the like stored in a waveform memory (not shown) and outputs the position control signal to drive signal supply section 103.

Drive signal supply section 103 supplies a desired drive signal to coils 44a and 44b of rotary reciprocating drive actuator 1 to drive reciprocating rotation of rotary reciprocating drive actuator 1 to scan the object.

The embodiment of the present invention has been described above. The above description is an example of a suitable embodiment of the present invention, and the scope of the present invention is not limited thereto. That is, the description of the configuration of the device and the shape of each part is an example, and it is clear that various changes and additions to these examples are possible within the scope of the present invention.

### INDUSTRIAL APPLICABILITY

The rotary reciprocating drive actuator according to the present invention is capable of generating high torque to achieve an increased amplitude, and has the effect of being reduced in size and hence in profile, and additionally, it is also easy to assemble and has the effect of being able to output high torque, and is particularly useful as one to be used in a scanner that rotates a mirror, where durability is required.

### REFERENCE SIGNS LIST

1 Rotary reciprocating drive actuator
4 Drive unit
10 Movable body
11 Mirror part (rotatable object)
12, 13 Holder (mirror holder)
14 Second shaft part
15 First shaft part (shaft part)
16, 17, 18, 19 Fastening member
20 Fixed body
21 Base part
22, 24, 26 Bearing
23 Shaft movement restricting part
32 Magnet
32a S pole (magnetic pole)
32b N pole (magnetic pole)
32c Magnetic-pole switching portion
37 Pin (pin member)
40 Core assembly
41 First core
42 Second core
44, 44a, 44b Coil
46a, 46b Bobbin
48 Reference position holding part
49 Terminal
50 Bottom cover (attachment surface portion)
51, 62 Cover main body
52, 2111 Side portion (one side portion)
54, 2112 Side portion
53 Opening portion
55, 59 Fixing hole
56 Attachment hole
57 Positioning hole
58 Positioning projection
59 Fixing hole
60 Top cover (lid part)
63 Opening portion
64, 212b Counterbore portion
66 Through-hole
68 Boss portion
69 Arc-shaped boss portion
70 Rotation angle position detection section
72 Board
82 Preload spring
86, 88 Stopper
100 Scanner system
101 Laser light emitting section
102 Laser control section
103 Drive signal supply section
104 Position control signal calculation section
144, 154 Other end portion
152 One end portion
153 Depressed portion
210, 510 Corner portion
211 Wall portion (attachment target portion)
211a, 212a Insertion hole
211b Fixing hole
212 Wall portion
213 Bottom portion
213a Installation surface
224, 244, 264 Flange
400 Core body (core)
401 Space
402 Core groove portion
412a, 412b Rod-shaped body (rod-shaped magnetic material)
413 Connecting side portion
414 Step portion
422a, 422b Inclined side portion
422c Top side portion
422d Recessed portion
423 Bottom side portion
424 Inner bottom surface
431 Attachment hole
432 Fixing hole
433 Positioning hole
462 Bobbin main body
464 Terminal support portion
491 Other end portion
492 One end portion
822, 822A, 824, 824A Both end portion
588 Positioning projection portion
4231 Inner corner portion

1. A rotary reciprocating drive actuator, comprising:
an attachment surface portion joined to an attachment target portion;
a rotatable shaft part that protrudes from a predetermined position of the attachment surface portion and to which a movable object is connected;
a magnet fixed to an outer periphery of the rotatable shaft part;
a core including:
a pair of rod-shaped magnetic materials having magnetic poles at distal end portions, the magnetic poles facing an outer periphery of the magnet and
a frame-shaped magnetic material connected to base end portions of the pair of rod-shaped magnetic materials and forming a magnetic path surrounding the magnet and the magnetic poles; and
a coil that generates magnetic flux in the core through energization to reciprocally rotate the rotatable shaft part, the magnetic flux interacting with the magnet, wherein
the predetermined position is a position eccentrically offset from a center in a direction towards a corner portion on the attachment surface portion, and
the pair of rod-shaped magnetic materials are symmetrically disposed with respect to an oblique line extending in the direction.

2. The rotary reciprocating drive actuator according to claim 1, wherein
the oblique line is a diagonal line of the attachment surface portion.

3. The rotary reciprocating drive actuator according to claim 1, wherein
the frame-shaped magnetic material includes an inclined side portion extending at an inclined angle to the pair of rod-shaped magnetic materials, and the inclined side portion is disposed to overlap one side portion of the attachment surface portion.

4. The rotary reciprocating drive actuator according to claim 1, wherein:
the frame-shaped magnetic material includes a pair of inclined side portions symmetrically disposed with respect to the oblique line, and
both of the pair of inclined side portions include attachment holes formed to fix the core to the attachment surface portion in an axial direction via a fastening member.

5. The rotary reciprocating drive actuator according to claim 1, wherein:
the core and the coil are integrally fixed to the attachment surface portion, and
the attachment surface portion has a pair of attachment holes for fixing the attachment surface portion to the attachment target portion, the pair of attachment holes being disposed at positions on another oblique line extending in a direction intersecting the oblique line, the positions being located so as to avoid the core.

6. The rotary reciprocating drive actuator according to claim 2, further comprising:
a core assembly including the core and the coil, wherein
a plate-shaped lid part is disposed to cover one end portion side of the core assembly such that one end portion side of the rotatable shaft part is inserted through the plate-shaped lid part,
the core assembly is fixed to the attachment surface portion at an other end portion side of the rotatable shaft part, and
the plate-shaped lid part includes a boss portion protruding towards the core assembly side and being engaged internally with the core assembly to restrict circumferential rotation centered on the rotatable shaft part.

7. The rotary reciprocating drive actuator according to claim 6, wherein
the core assembly is fixed to the attachment surface portion by insertion of a pin member configured to be inserted through the attachment surface portion in an axial direction.

8. The rotary reciprocating drive actuator according to claim 6, wherein
the boss portion includes an arc-shaped boss portion protruding towards the core assembly side around an opening portion of the plate-shaped lid part through which the rotatable shaft part is inserted, the arc-shaped boss portion being engaged internally with the core assembly around the rotatable shaft part.

9. The rotary reciprocating drive actuator according to claim 7, wherein:
the coil is disposed on an outer periphery of a middle portion of each of the pair of rod-shaped magnetic materials,
the core assembly includes a terminal part connected to the coil and disposed close to a side of the base end portions of the pair of rod-shaped magnetic materials with respect to the coil, and
the pin member is inserted in the core assembly to a position separated from the terminal part in the axial direction and at a position overlapping the terminal part when viewed in a plane orthogonal to the axial direction.

10. The rotary reciprocating drive actuator according to claim 9, wherein:
the plate-shaped lid part includes a circuit board, and
the terminal part has one end portion protruding on the plate-shaped lid part side and connected to the circuit board.

11. The rotary reciprocating drive actuator according to claim 1, wherein
the movable object is a mirror that reflects scanning light.
